(19) United States
(12) Patent Application Publication
(10) Pub. No.: US 2024/0098719 A1
(43) Pub. Date: Mar. 21, 2024

(54) Technique for Operating in Spectrum Not Aligned with Channel Bandwidth of a Radio Access Technology

(71) Applicant: Telefonaktiebolaget LM Ericsson (publ), Stockholm (SE)

(72) Inventors: Esther Sienkiewicz, Ottawa (CA); Christian Bergljung, Lund (SE); Fredrik Sundström, Sundbyberg (SE)

(21) Appl. No.: 18/272,056

(22) PCT Filed: Jan. 17, 2022
(86) PCT No.: PCT/EP2022/050904

§ 371 Date: Jul. 12, 2023

Related U.S. Application Data
(60) Provisional application No. 63/138,271, filed on Jan. 15, 2021.

(51) Int. Cl. H04W 72/0453; H04W 72/51

(52) U.S. Cl. CPC H04W 72/0453; H04W 72/51

(57) ABSTRACT

Techniques are provided to enable radio devices to operate using irregular bandwidths that are not defined channel bandwidths by the applicable RAT. A UE designed to limit emissions outside the irregular bandwidth block but within the channel bandwidth can indicate this capability when it accesses the network. When a UE indicates a capability to use irregular bandwidths, the network can schedule the UE in an irregular bandwidth block while blanking the part of the channel bandwidth outside the irregular bandwidth block in order to maximize the use of the irregular bandwidth block. If a UE does not indicate capability for using irregular bandwidth blocks, the network can schedule the UE in a defined bandwidth inside the irregular bandwidth block provided there is a defined channel bandwidth less than the irregular block bandwidth.

### TECHNICAL FIELD

The present disclosure relates to a technique for operating in spectrum not aligned with channel bandwidth of a radio access technology. More specifically, and without limitation, methods and devices are provided for scheduling and operating a radio device in a block bandwidth within a channel bandwidth of a radio access technology.

### BACKGROUND

In 2016, the Third-Generation Partnership Project (3GPP) started a Study Item to investigate development of a new radio access technology (RAT), now called new Radio (NR), for a Fifth Generation (5G) wireless communication network. followed in 2017 by a Work Item to develop corresponding specifications. NR can enable a wider range of use cases than predecessor cellular radio technologies. Potential use cases include mobile broadband (MBB), ultra-reliable low latency communication (URLLC), machine type communication (MTC), device to device (D2D), vehicle to vehicle (V2V) and vehicle to infrastructure communication (V2X). An important factor for the realization of these use cases is an increase in spectral efficiency (also referred to as spectral utilization) compared to legacy systems, such as 3GPP Long Term Evolution (LTE). In addition to higher spectral efficiency, NR enables the use of multiple numerologies within a given carrier with the aim of providing service to radio devices (i.e., user equipment (UEs)) with varied demand requirements.

As of Release 16, 3GPP defined channel bandwidths of 5 MHz, 10 MHz, 15 MHz, 20 MHz, 25 MHz, 30 MHz, 40 MHz, 50 MHz, 60 MHz, 70 MHz, 80 MHz, 90 MHz, and 100 MHz for NR according to the 3GPP document TS 38.101-1, version 17.0.0. The finest granularity under the standard is 5 MHz. Minimum transmitter and receiver radio requirements for the base station (BS) and the UE are specified for these channel bandwidths. These requirements also include regulatory requirements applicable in different International Telecommunication Union Radiocommunication (ITU-R) regions. Compliance with the 3GPP requirements for a channel bandwidth implies compliance with applicable regulatory requirements.

One area of concern is unwanted emissions including out-of-band emissions (OOBE) outside the channel bandwidth due to modulation and non-linearities at the transmitter and spurious emissions outside the OOBE region. 3GPP specifies OOBE in terms of spectrum masks and adjacent channel leakage ratio (ACLR) and spurious emissions requirements in terms of emissions limits. These requirements only apply outside the channel bandwidth for any Physical Resource Block (PRB) allocation inside the channel bandwidth, but are not ensured outside specific PRB allocations inside the said channel bandwidth or outside bandwidth parts (BWPs) configured within the channel bandwidth.

Radio spectrum is a scarce resource, and costly investment into spectrum auctions bring the concern of utilizing the allocation of spectrum efficiently in the licensed spectrum. However, some block bandwidths (e.g., operator bandwidths such as spectrum allocations or spectrum blocks) do not align with the channel bandwidths selectable for NR as the radio access technology (RAT). Thus, it is currently not possible to use such spectrum efficiently or even not at all.

As one example, a 3 MHz block bandwidth exists within the band “n28” (e.g., between 733-736 MHz as well as between 788-791 MHz) between the lower duplexer of Band 28 and Band 20 in many countries across Region 1 of the International Telecommunication Union (ITU), where both bands are either deployed or to be deployed for Long Term Evolution (LTE) and 5G NR. This 3 MHz block bandwidth could be deployed in combination with an adjacent 10 MHz of Band 28. However, 3GPP does not support either a 3 MHz or 13 MHz carrier bandwidth for the combination within the 700 MHz band (e.g., 3GPP n28).

Due to scarcity of the radio spectrum, techniques enabling radio devices (e.g. base stations and UEs) to operate in spectrum not aligned with the channel bandwidth of 5G/NR would be of interest to network operators.

### SUMMARY

Exemplary embodiments of the present disclosure provide techniques enabling radio devices to operate using irregular bandwidths that are not defined channel bandwidths by the applicable RAT. The techniques herein described enable more efficient use of the radio spectrum and thus increase the spectral efficiency of the system while avoiding unwanted spectral emissions outside the irregular bandwidth. These benefits are realized by suing standard channel bandwidths larger than the irregular bandwidth block and blanking the part of the channel bandwidth outside the irregular bandwidth block. A UE designed to limit emissions outside the irregular bandwidth block but within the channel bandwidth can indicate this capability when it accesses the network. When a UE indicates a capability to use irregular bandwidths, the network can schedule the UE in an irregular bandwidth block while blanking the part of the channel bandwidth outside the irregular bandwidth block in order to maximize the use of the irregular bandwidth block. If a UE does not indicate capability for using irregular bandwidth blocks, the network can schedule the UE in a defined bandwidth inside the irregular bandwidth block provided there is a defined channel bandwidth less than the irregular block bandwidth.

A first aspect of the disclosure comprises methods implemented by a UE of operating in a block bandwidth within a channel bandwidth of a radio access technology (RAT) for radio access to a radio access network (RAN). In one embodiment, the method comprises transmitting, to a base station in the RAN, a capability message indicative of whether or not the UE is capable of fulfilling a limit within the channel bandwidth of the RAT on radio emissions outside of the block bandwidth when transmitting in the block bandwidth. The method further comprises receiving, from the base station, a scheduling message indicative of radio resources scheduled by the base station depending on the capability indicated by the capability message.

A second aspect of the disclosure comprises methods implemented by a base station in a RAN of operating in a block bandwidth within a channel bandwidth of a radio access technology (RAT) for radio access to a radio access network (RAN). One embodiment of the method comprises receiving, from a UE, a capability message indicative of whether or not the UE is capable of fulfilling a limit within the channel bandwidth of the RAT on radio emissions outside of the block bandwidth when transmitting in the block bandwidth. The method further comprises transmitting, to the UE, a scheduling message indicative of radio resources scheduled by the base station depending on the capability indicated by the capability message.

A third aspect of the disclosure comprises a UE configured to operate in a block bandwidth within a channel bandwidth of a radio access technology (RAT) for radio access to a radio access network (RAN). In one embodiment, the UE is configured to transmit, to a base station in the RAN, a capability message indicative of whether or not the UE is capable of fulfilling a limit within the channel bandwidth of the RAT on radio emissions outside of the block bandwidth when transmitting in the block bandwidth. The UE is further configured to receive, from the base station, a scheduling message indicative of radio resources scheduled by the base station depending on the capability indicated by the capability message.

A fourth aspect of the disclosure comprises a base station in a RAN configured to operate in a block bandwidth within a channel bandwidth of a radio access technology (RAT) for radio access to a radio access network (RAN). In one embodiment, the base station is configured to receive, from a UE, a capability message indicative of whether or not the UE is capable of fulfilling a limit within the channel bandwidth of the RAT on radio emissions outside of the block bandwidth when transmitting in the block bandwidth. The base station is further configured to transmit, to the UE, a scheduling message indicative of radio resources scheduled by the base station depending on the capability indicated by the capability message.

A fifth aspect of the disclosure comprises a UE including interface circuitry for communicating with a base station over a wireless communication channel and processing circuitry configured to operate in a block bandwidth within a channel bandwidth of a radio access technology (RAT) for radio access to a radio access network (RAN). In one embodiment, the processing circuitry is configured to transmit, to a base station in the RAN, a capability message indicative of whether or not the UE is capable of fulfilling a limit within the channel bandwidth of the RAT on radio emissions outside of the block bandwidth when transmitting in the block bandwidth. The processing circuitry is further configured to receive, from the base station, a scheduling message indicative of radio resources scheduled by the base station depending on the capability indicated by the capability message.

A sixth aspect of the disclosure comprises a base station including interface circuitry for communicating with a base station over a wireless communication channel and processing circuitry configured to operate in a block bandwidth within a channel bandwidth of a radio access technology (RAT) for radio access to a radio access network (RAN). In one embodiment, the processing circuitry is configured to receive, from the a UE, a capability message indicative of whether or not the UE is capable of fulfilling a limit within the channel bandwidth of the RAT on radio emissions outside of the block bandwidth when transmitting in the block bandwidth. The processing circuitry is further configured to transmit, to the UE, a scheduling message indicative of radio resources scheduled by the base station depending on the capability indicated by the capability message.

A seventh aspect of the disclosure comprises a computer program comprising executable instructions that, when executed by a processing circuit in a UE, causes the UE to perform the method according to the first aspect.

An eighth aspect of the disclosure comprises a carrier containing a computer program according to the seventh aspect wherein the carrier is one of an electronic signal, optical signal, radio signal, or computer readable storage medium.

A ninth aspect of the disclosure comprises a computer program comprising executable instructions that, when executed by a processing circuit in a base station, causes the base station to perform the method according to the second aspect.

A tenth aspect of the disclosure comprises a carrier containing a computer program according to the ninth aspect wherein the carrier is one of an electronic signal, optical signal, radio signal, or computer readable storage medium.

### BRIEF DESCRIPTION OF THE DRAWINGS

Further details of embodiments of the technique are described with reference to the enclosed drawings, wherein:

FIG. 1 illustrates a wireless communication network according to an exemplary embodiment.

FIG. 2 schematically illustrates an example of a channel bandwidth which may be usable by the devices of FIGS. 1 and 2 for performing the methods of FIGS. 3 and 4, respectively.

FIG. 3 schematically illustrates examples of a maximum power reduction, which may be usable by the devices of FIGS. 1 and 2 for performing the methods of FIGS. 3 and 4, respectively.

FIG. 4 schematically illustrates examples of a block bandwidth, which may be usable by the devices of FIGS. 1 and 2 for performing the methods of FIGS. 3 and 4, respectively.

FIG. 5 schematically illustrates examples of a blanked bandwidth, which may be usable by the devices of FIGS. 1 and 2 for performing the methods of FIGS. 3 and 4, respectively.

FIG. 6 schematically illustrates examples of a component carrier, which may be usable by the devices of FIGS. 1 and 2 for performing the methods of FIGS. 3 and 4, respectively.

FIG. 7 schematically illustrates an example of a signaling diagram for an embodiment of an attach procedure, which may be usable by the devices of FIGS. 1 and 2 for performing the methods of FIGS. 3 and 4, respectively.

FIG. 8 schematically illustrates an example of a signaling diagram for an embodiment of a later attach procedure, which may be usable by the devices of FIGS. 1 and 2 for performing the methods of FIGS. 3 and 4, respectively.

FIG. 9 schematically illustrates examples of different sizes of the block bandwidth as capabilities of the radio device of FIG. 1, which may be usable by the device of FIG. 2 for performing the methods of FIGS. 3 and 4, respectively.

FIG. 10 schematically illustrates an example of an overlapping method, which may be usable by the devices of FIGS. 1 and 2 for performing the methods of FIGS. 3 and 4, respectively.

FIG. 11 schematically illustrates an example of a situation using power reduction, which may be usable by the devices of FIGS. 1 and 2 for performing the methods of FIGS. 3 and 4, respectively.

FIG. 12 schematically illustrates an example of a carrier aggregation, which may be usable by the devices of FIGS. 1 and 2 for performing the methods of FIGS. 3 and 4, respectively.

FIG. 13 schematically illustrates an example implementation of the method enabling efficient use of irregular bandwidths.

FIG. 14 illustrates a method implemented by a UE configured to use an irregular bandwidth as herein described.

FIG. 15 illustrates a method implemented by a base station configured to use an irregular bandwidth as herein described.

FIG. 16 illustrates a UE configured to use an irregular bandwidth as herein described.

FIG. 17 illustrates a base station configured to use an irregular bandwidth as herein described.

FIG. 18 shows a schematic block diagram of a UE configured to use an irregular bandwidth as herein described.

FIG. 19 shows a schematic block diagram of a base station configured to use an irregular bandwidth as herein described.

FIG. 20 schematically illustrates an example telecommunication network connected via an intermediate network to a host computer.

FIG. 21 shows a generalized block diagram of a host computer communicating via a base station or radio device functioning as a gateway with a user equipment over a partially wireless connection.

FIGS. 22 and 23 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

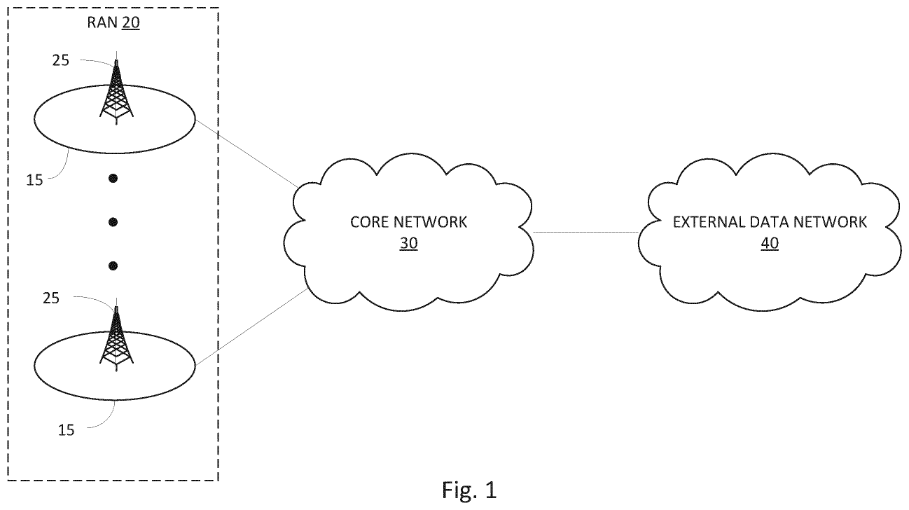

FIG. 1 illustrates a wireless communication network indicated generally by the numeral 10. The wireless communication network 10 generally comprises a radio access network (RAN) 20 and a core network (CN) 30. The RAN 20 comprises one or more base stations 200, also called access nodes or radio network nodes, providing service to one or more user equipment (UE) 100 in respective cells 15 of the mobile communication network 10. The base stations 200 provide the UEs 100 with access to the CN 30, which provides a gateway for access to external data networks 40, such as the Internet or Internet Protocol (IP) Multimedia Subsystem (IMS) network. The UEs 100 may comprise any equipment or device capable or communication with the base station including, but not limited to smart phones, cellular telephones, tablets, notebooks, laptop computers, machine-type communication (MTC) devices).

3GPP standards for NR define channel bandwidths of 5 MHz, 10 MHz, 15 MHz, 20 MHz, 25 MHz, 30 MHz, 40 MHz, 50 MHz, 60 MHz, 70 MHz, 80 MHz, 90 MHz, and 100 MHz for NR. The finest granularity under the standard is 5 MHz.

Radio requirements for each channel bandwidth are specified up to a maximum PRB allocation within the bandwidth, referred to herein as the maximum transmission bandwidth configuration, which defines the spectrum utilization. Internal guard bands at the channel edges constitute the remaining part of the channel bandwidth to meet emission requirements outside the channel bandwidth ensure for all PRB allocations up to the maximum transmission bandwidth configuration.

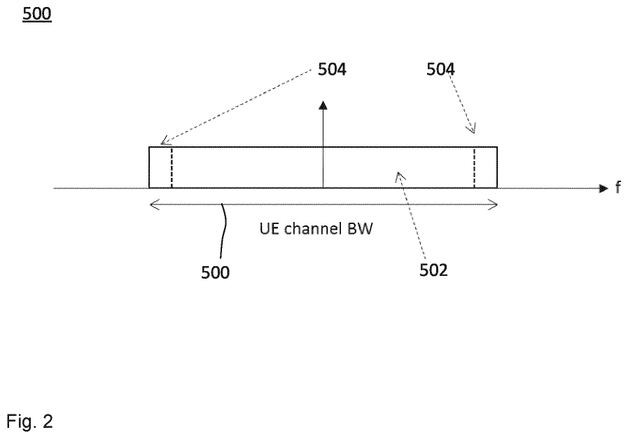

FIG. 2 illustrates a maximum transmission bandwidth configuration and internal guard bands as specified by 3GPP TS 38.101-1, v. 17, clause 5.3.3. A minimum guardband 504 for each UE channel bandwidth and sub-carrier spacing (SCS) is specified. Table 1 below shows the minimum guardbands specified by 3GPP.

TABLE 1
Minimum guardband for each UE channel bandwidth and SCS (kHz)

| SCS | 5 | 10 | 15 | 20 | 25 | 30 | 40 | 50 | 60 | 70 | 80 | 90 | 100 |
|---|---|---|---|---|---|---|---|---|---|---|---|---|---|
| (kHz) | MHz | MHz | MHz | MHz | MHz | MHz | MHz | MHz | MHz | MHz | MHz | MHz | MHz |
| 15 | 242.5 | 312.5 | 382.5 | 452.5 | 522.5 | 592.5 | 552.5 | 692.5 | N/A | N/A | N/A | N/A | N/A |
| 30 | 505 | 665 | 645 | 805 | 785 | 945 | 905 | 1045 | 825 | 965 | 925 | 885 | 845 |
| 60 | N/A | 1010 | 990 | 1330 | 1310 | 1290 | 1610 | 1570 | 153 | 1490 | 1450 | 1410 | 1370 |

Alternatively or in addition, the minimum guardbands 504 may be calculated using the following equation:

(BW_{Channel}×1000(kHz)−N_{RB}×SCS×12)/2−SCS/2,

wherein N_{RB} are specified by 3GPP TS 38.101-1, v. 17, clause 5.3.2. Table 2 shows N_{RB} for different channel bandwidths.

TABLE 2
NRB for each UE channel bandwidth

| | 5 | 10 | 15 | 20 | 25 | 30 | 40 | 50 | 60 | 70 | 80 | 90 | 100 |
|---|---|---|---|---|---|---|---|---|---|---|---|---|---|
| SCS | MHz | MHz | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A | N/A |
| 30 | 11 | 24 | 38 | 51 | 65 | 78 | 106 | 133 | 162 | 189 | 217 | 245 | 273 |
| 60 | N/A | 11 | 18 | 24 | 31 | 38 | 51 | 65 | 79 | 93 | 107 | 121 | 135 |

Radio resources 502 (e.g., PRBs) falling within the channel bandwidth and not covering the (e.g., minimum) guard band 504 can be used for data transmission. The number of RBs (NRB) configured in any channel bandwidth ensures that the minimum guardband 504 is met.

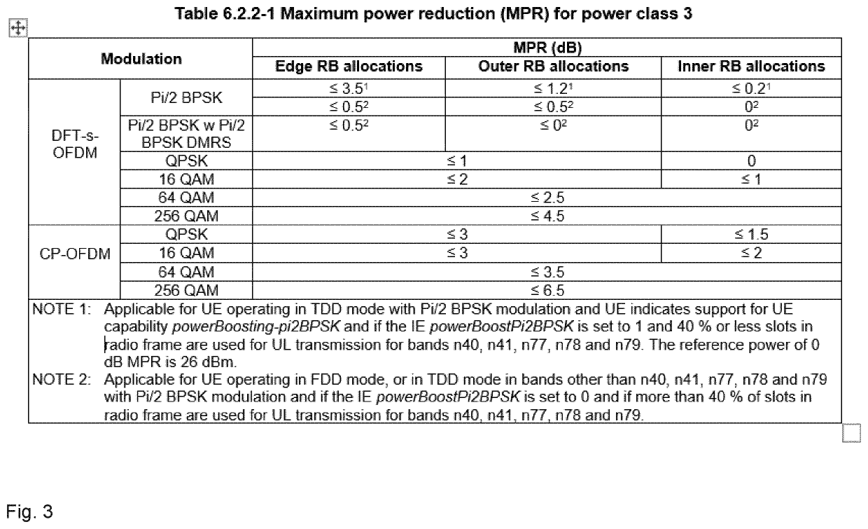

A UE 100 may use power back-off (i.e., power reduction) to comply with unwanted-emissions requirements, i.e., for fulfilling the limit according to the capability, e.g., as described below. The UE 100 is allowed to reduce its output power up to a certain level, the maximum power reduction (MPR), to facilitate compliance with the standard 3GPP unwanted-emissions requirements. The MPR depends on the PRB (frequency) allocation within the channel bandwidth as shown in the example in FIG. 3. FIG. 3 schematically illustrates examples of a maximum power reduction (MPR), which may be usable by the UE 100 for fulfilling the limit. More specifically, FIG. 3 illustrates an allowed MPR for at least one of inner, outer, and edge PRB allocations, e.g., according to the 3GPP document TS 38.101-1, version 17.0.0. The inner, outer and edge allocations are specified in terms of the position and number of consecutive PRBs in the frequency domain and the maximum bandwidth configuration, and hence tied to the channel bandwidth. The MPR is typically larger for the edge and outer allocations, e.g. as detailed in the 3GPP document TS 38.101-1, version 17.0.0.

For compliance with regional-specific unwanted-emissions limits applicable in certain geographical areas the UE 100 is allowed additional MPR (A-MPR). These limits are indicated to the UE 100 by the base station 200 (e.g., the RAN is signaling values for the limits). The A-MPR is also dependent on the PRB allocation and tied to the channel bandwidth.

In some scenarios, irregular bandwidths and spectrum block sizes may be used for communication between a UE 100 and base station 200. For example, irregular bandwidths can be used during initial access and use of a spectrum block for two different RATs within a single licensed spectrum (operator) block.

One technique for using irregular bandwidths is referred to herein as the overlap technique. For NR, the base station 200 can configure any carrierBandwidth of a serving cell that is not necessarily aligned with the channel bandwidth specified for the UE 100. The carrierBandwidth is indicated in terms of resource blocks (PRB) fitting the available spectrum block with due allowance of internal guard bands on either side of the PRBs. If the carrierBandwidth and the internal guard bands are not aligned with the maximum PRB configuration (the maximum transmission bandwidth configuration) and the internal guard of a UE channel bandwidth (MHz), the UE 100 may not meet regular unwanted-emissions requirements. To this end, the procedure for UE initial access to a cell was modified such that a cell is considered suitable only if the UE 100 supports a channel bandwidth (MHz) with a maximum transmission bandwidth configuration (PRB) less than or equal to the carrierBandwidth, thus ensuring that any attached UE 100 would not violate regulatory emissions requirements.

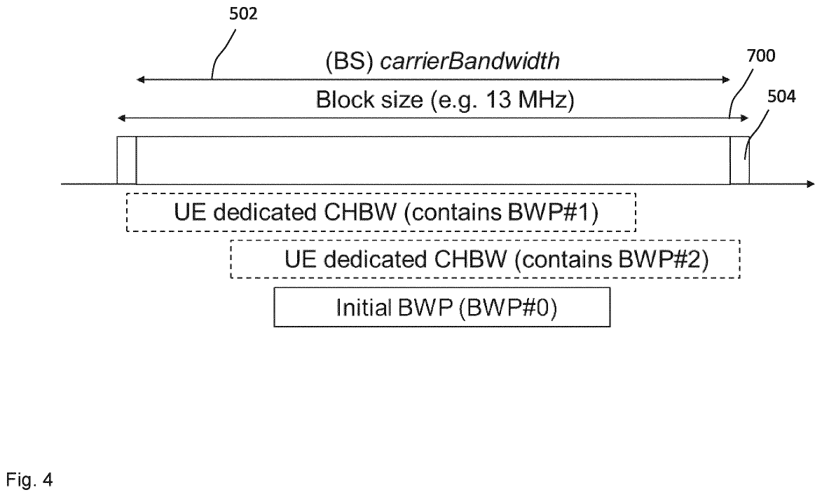

FIG. 4 schematically illustrates overlapping bandwidths in a spectrum block size not aligned with UE channel bandwidths. In the example of an irregular bandwidth illustrated in FIG. 4, the irregular bandwidth (i.e., the available spectrum) is 13 MHz. The UE 100 must support the 5 MHz or 10 MHz channel bandwidths 500 to attach to the cell. Moreover, the base station 200 can configure the UE 100 with a dedicated channel bandwidth (CHBW) 500 in accordance with the channel bandwidths 500 supported by the said UE 100 (indicated by the UE 100 to the base station 200 as part of the UE capability of the UE 100), which would meet the emission requirements outside this dedicated bandwidth and hence also the emissions requirements outside the block.

In one method for supporting irregular bandwidths, the RAN configures the UE 100 with a dedicated CHBW that is smaller than the (irregular) spectrum block size. In the example two existing UE channel bandwidths of 10 MHz are overlapped in frequency. The initial bandwidth part (BWP #0), and thus the corresponding CORESET #0, fits within both of the configured UE dedicated channel bandwidths, i.e. in the overlap of the dedicated channel bandwidths. The minimum bandwidth for CORESET #0 (e.g., for a SCS of 15 kHz) is 4.32 MHz. The minimum bandwidth for CORESET #0 is given by a minimum of 24 PRBs, e.g., according to Table 13-4 in the 3GPP document TS 38.213, version 16.4.0. One PRB comprises 12 subcarriers giving a PRB bandwidth of 15 kHz×12=180 kHz. Multiplying the PrB bandwidth by the number of PRBs, e.g., 24 in this example, gives 180 kHz×24=4.32 MHz, which fits in the overlap between the two 10 MHz bandwidths in the 13 MHz block. However, this method of overlapping bandwidths does not work for a block size (i.e., an available carrier bandwidth) less than 10 MHz because the minimum bandwidth of CORESET #0 (4.32 MHz) does not fit within both overlapping UE channels bandwidths and can hence not be used.

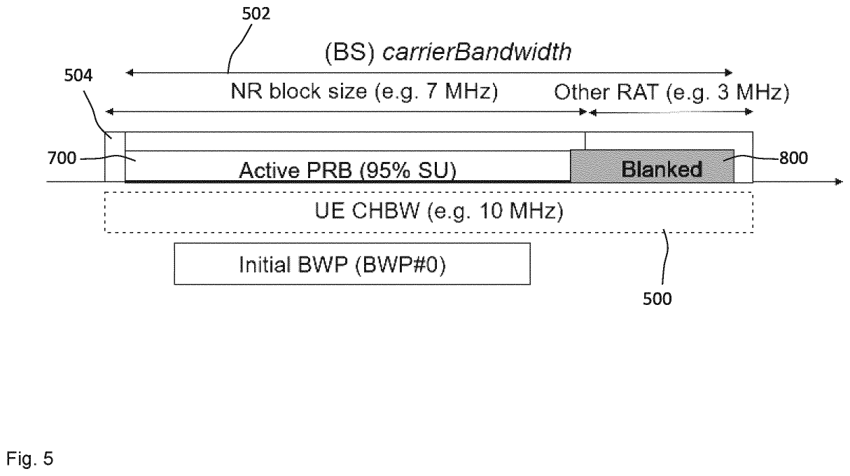

Another method of supporting irregular bandwidths is referred to herein as the blanking method. The blanking method enables two RATS to share an operator block of 10 MHz resulting in an NR spectrum block of irregular size less than 10 MHz. To this end the NR PRB are blanked (i.e., not scheduled) in the part used for the other radio access technology (RAT) as shown in example in FIG. 5 with an NR part occupying a 7 MHz block and the other RAT using 3 MHz. The carrierBandwidth must still correspond to a 10 MHz channel bandwidth for UEs 100 supporting the 10 MHz carrier bandwidth to attach. UEs 100 only supporting the 5 MHz bandwidth would also attach with the initial BWP suitably configured, but the behavior if a BWP occupying the entire 7 MHz exceeding the UE channel bandwidth would be undefined.

Using the blanking method, unwanted-emissions requirements for the UE 100 are not necessarily met in the blanked part. For larger differences, e.g., the 7 MHz case where the next larger channel bandwidth is 10 MHz, the unused 3 MHz is blanked. Operating at 7 MHz by blanking the UE 100 is not guaranteed to fulfill those RF requirements and hence it might not pass some regulatory RF requirements by conformance tests. In other words, how will these different internal guards be handled by regulators. However, the other RAT in the 3 MHz typically belongs to the same operator so any interference must be accepted (or coordination used to reduce interference). Otherwise irregular channel NR bandwidths could also be supported with the next larger channel bandwidth applied with remaining RBs blanked, now with another network/operator in the blanked part.

An alternative to the overlap and blanking methods is to specify the irregular bandwidths in the standard as regular channel bandwidths. in this case, the base station 200 and UE must comply with (and be designed for) all transmitter and receiver RF requirements and the radio resource management (RRM) requirements, which applies for channel bandwidths supported by the BS 200/UE 100.

As seen above, spectrum blocks or allocations do not always match the channel bandwidths. In order to utilize the channel bandwidths operators must use 3GPP defined channel bandwidths only, leaving under-utilized licensed spectrum. The overlap and blanking methods do not fully utilize the operator licensed irregular channel bandwidths.

Radio requirements for carrier aggregation (CA) and supplementary UL are also specified in the NR standards in terms of the channel bandwidth. As in LTE, multiple NR carriers can be aggregated and transmitted in parallel to and from the same UE 100 in order to increase the total transmission bandwidth beyond the maximum per carrier and thereby the user- and system data rates. Carrier aggregation can be configured both in the downlink and uplink directions. The aggregated carriers are denoted component carriers.

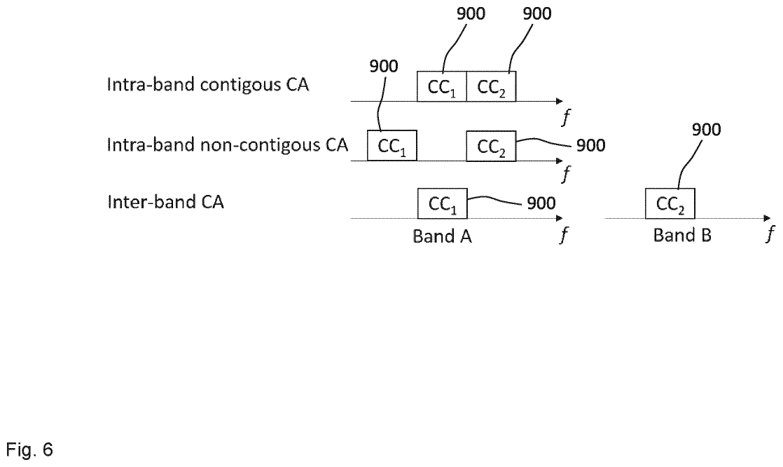

FIG. 6 schematically illustrates examples of a component carrier 900, which may be usable by the UE 100 and base station 200 for performing the methods 300 and 400, respectively. More specifically, FIG. 6 illustrates different configurations of carrier aggregation (e.g., uplink or downlink in each case).

For CA, each component carrier (CC) 900 corresponds to a serving cell providing radio services. One of the cells is denoted the primary cell (PCell), a carrier operating on the primary frequency, in which the UE 100 either performs the initial establishment of the connection or initiates re-establishment of the connection if this is lost. One or more secondary cells (SCell), component carriers operating on secondary frequencies, can then be added (aggregated) or released (removed) as appropriate e.g. depending on the radio-link conditions.

Different number of CCs 900 (also referred to as cells 900) can be aggregated in the downlink and uplink, a serving cell has a downlink and an uplink carrier or only a downlink carrier (the latter only for SCells) number of uplink carriers cannot exceed the number of downlink carriers. Aggregated component carriers do not have to be contiguous (adjacent) in frequency; carriers can be aggregated within a frequency band (intra-band CA) or between frequency bands (inter-band CA) or in a combination of intra-band and inter-band CA. For intra-band CA, CCs 900 can be contiguous or non-contiguous.

Related to carrier aggregation is the concept of supplementary uplink (SUL). For SUL, a single cell consists of one downlink carrier and two uplink carriers at two carrier frequencies that are usually in different bands: the normal uplink (NUL) associated with the downlink carrier and the SUL. Hence for a cell with SUL the number of uplink carriers is larger than the number of downlink carriers.

The serving cells are contained within one or two cell groups (CG), each cell group associated with a network node. Dual connectivity (DC) allows a UE 100 to communicate with two cell groups, the master cell group (MCG) associated with a master node (e.g. an LTE eNB or and NR gNB), and a secondary cell group (SCG) associated with a secondary node (e.g. an LTE eNB or and NR gNB). Carriers can be aggregated within a cell group. For NR, the UE 100 is configured with at least one cell group; the MCG if the UE 100 is not configured with DC.

One aspect of the present disclosure is to provide techniques for more efficiently utilizing irregular spectrum allocations with irregular bandwidths that do not match the regular channel bandwidths of the RAT while meeting emissions requirements outside of the irregular bandwidth. It is desirable that the network and the UE 100 comply with unwanted emissions requirements outside the operator block of an irregular bandwidth. However, a UE 100 designed for standardized bandwidths may not meet the unwanted emission requirements when operating in an irregular bandwidth and being scheduled in a smaller bandwidth using the PRB blanking as previously described, e.g., where the UE 100 is. scheduled in a 7 MHz BWP instead of the higher standardized BW of 10 MHz.

In an embodiment of the present disclosure, a UE 100 designed to limit emissions outside an irregular bandwidth block but within the channel bandwidth of the base station can indicate this capability when it accesses the network. For example, the UE 100 can indicate that it supports all UE RF unwanted emission requirements if it is scheduled with a narrower bandwidth than the indicated base station carrier bandwidth by the means of PRB blanking by the base station. When a UE 100 indicates a capability to use irregular bandwidths, the network can schedule the UE 100 in an irregular bandwidth block in both the uplink and downlink while blanking the part of the channel bandwidth outside the irregular bandwidth block in order to maximize the use of the irregular bandwidth block while complying with regulatory RF emission requirements. If a UE 100 does not indicate capability for using irregular bandwidth blocks, the network can schedule the UE 100 in a defined bandwidth inside the irregular bandwidth block provided there is a defined channel bandwidth less than the irregular block bandwidth.

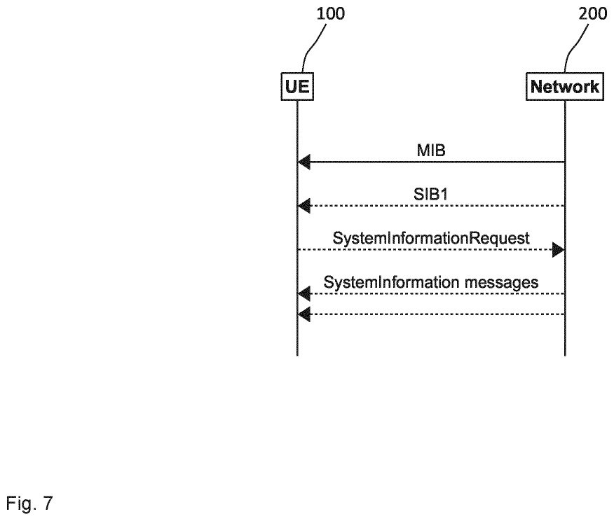

Information as to the block bandwidth 700 may be provided from the base station 200 to the UE 100 in an attach procedure. FIG. 7 schematically illustrates an example of a signaling diagram for an embodiment of an attach procedure, which may be usable by the UE 100 and base station 200 performing the methods 300 and 400, respectively. As illustrated in FIG. 7, general system information (SI) may be acquired by the UE 100 from the RAN 200, e.g. according to 3GPP document TS 38.331, version 16.3.1, clause 5.2.2. The UE 100 may read the Master Information Block (MIB) information (e.g. according to 3GPP document TS 38.331, version 16.3.1) during the initial part of the attach procedure, the CORESET #0 will be defined as part of the initial BWP (BWP #0). Upon receiving the MIB, the UE 100 may continue and receiving and decoding SIB1 and any other scheduled SI blocks. The details regarding System Information (SI) acquisition and the action upon receipt of SI is described in the 3GPP document TS 38.331, version 16.3.1, clauses 5.2.2.3 and 5.2.2.4 respectively.

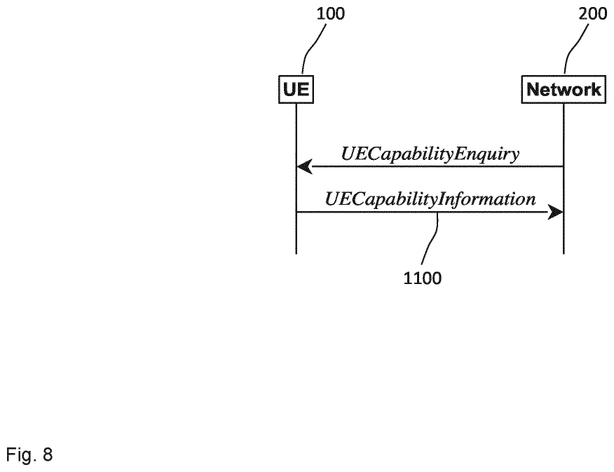

In a later part of the Attach procedure, as well as the UE procedure for changing RRC state from RRC IDLE to RRC CONNECT, the base station in the RAN 200 requests the UE 100 to provide its capabilities. FIG. 8 schematically illustrates an example of a signaling diagram for an embodiment of a later attach procedure, which may be usable by the UE 100 and base station 200 performing the methods 300 and 400, respectively. As illustrated in FIG. 8, UE Capability as an example of the capability message 1100 is transmitted from the UE 100 to the RAN 200, e.g., based on or by extending the 3GPP document TS 38.331, version 16.3.1, clause 5.6

The UECapabilityInformation Information Element (IE) 1100 in FIG. 8 contains detailed information (as part of the sub-IE UE-NR-Capability) on which features/configurations the UE 100 supports. The detailed content of the UECapabilityInformation IE can be found in the 3GPP document TS 38.331, version 16.3.1, clause 6.2.2. The UE 100 indicates, for example, which of the defined bandwidths it supports per NR band. In 3GPP TS 38.101-1, v. 17.0.0, Table 5.2-1 defines all NR FR1 operating bands and Table 5.3.5-1 defines the different channel bandwidths per operating band.

To comply with unwanted emissions requirements outside the operator block of an irregular bandwidth, the network may configure an UL and DL grid size carrierBandwidth in the system information that is greater than the bandwidth of the operator block (MHz) in order for all UEs 100 to attach to the network. The maximum UL and DL BWP size configured within the operator block with the remaining PRBs blanked such that the base station 200 can meet the unwanted-emissions requirements outside the operator block, which may require implementation of an operator-specific bandwidth in the base station 200 (existing technology).

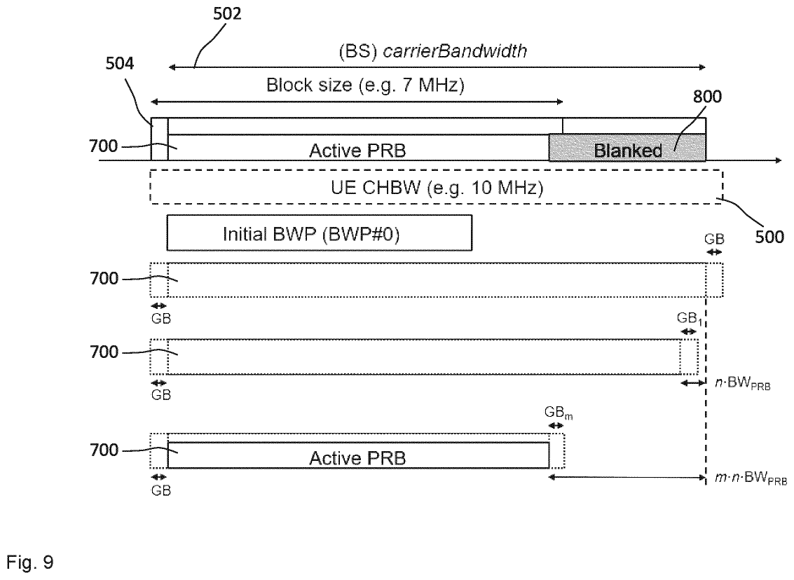

The UE 100 supports (e.g., as indicated in its UE capability in the step 302) a channel bandwidth CHBW (e.g., comprising a size of the CHBW, optionally in MHz) with a maximum transmission configuration equal to the carrierBandwidth, e.g. 10 MHz with an operator block of 7 MHz as shown in FIG. 9. Furthermore, the UE 100 must support the larger channel bandwidth CHBW (10 MHz in the example) just exceeding the operator block size to fully utilize the maximum BWP size shown as ‘active PRB’ in FIG. 9; the UE 100 complies with the transmitter requirements outside the channel bandwidth CHBW. The UE 100 may also support a channel bandwidth smaller with a maximum transmission configuration smaller than the carrierBandwidth, e.g. 5 MHz.

FIG. 9 schematically illustrates a examples of different sizes of the block bandwidth 700 as capabilities of the UE 100, which may be usable by the network node 200 for performing the methods 300 and 400, respectively. More specifically, FIG. 9 illustrates the blanking and supported irregular channel bandwidths 700 (briefly: bandwidths), CBWₘ.

In a first embodiment the UE 100 indicates in its UE capability that it complies with transmitter requirements in bandwidth that are a fraction of a supported (indicated) channel bandwidth CHBW with a certain granularity. The latter can be a set of irregular bandwidths with grid sizes of

N_{CHBW}−m·n

in number of PRBs, with N_{CHBW} the maximum transmission configuration of the supported channel bandwidth CHBW (e.g. 52 PRB for the 10 MHz channel bandwidth with SCS=15 kHz). The said transmitter requirement can be limited to unwanted-emissions requirements (i.e. not the full set of transmitter requirements).

The above grid sizes correspond to irregular bandwidths of

CBWₘ=GB+(N_{CHBW}−m·n)·BW_{PRB}+GBₘ<operator block size<CHBW (all in MHz),

wherein BW_{PRB} is the bandwidth of a PRB, GB the internal guard band below the active PRB and GBₘ an internal guard band within the operator block and partly overlapping with blanked PRBs with at least one of m and n conveyed by the UE capability available to the network after initial access. The 100 complies with the transmitter requirements outside the indicated bandwidths CBWₘ (MHz). The internal guard band GBₘ can be equal to the GB of the CHBW. In this embodiment at least the m, n and thus CBWₘ capabilities are indicated relative to the advertised CHBW such that CBWₘ<CHBW, but the range of irregular bandwidths could be limited such that

CHBW_{low}<CBWₘ<CHBW

with CHBW_{low} the next lower channel bandwidth possibly also supported by the UE 100, e.g. the 5 MHz channel bandwidth in FIG. 9.

In an alternative the bandwidths CBWₘ are indicated in the UE capability (values in MHz).

In a variation the m, n and resulting irregular bandwidth CBWₘ are indicated in the UE capability relative to the said next lower channel bandwidth CHBW_{low}

N_{CHBW,low}+m·n

with N_{CHBW,low} the maximum transmission configuration of the lower channel bandwidth CHBW_{low}. Using the blanking method, the UE 100 should also support the next greater CHBW in order to utilize the maximum BWP size shown as ‘active PRB’ in FIG. 9. Using the overlapping method, the UE 100 should also support a channel bandwidth with a maximum transmission configuration greater than the carrierBandwidth (or the operator block) such that a BWP covering the entire grid N_{CHBW,low} can be configured within the operator block, e.g. as illustrated in FIG. 9.

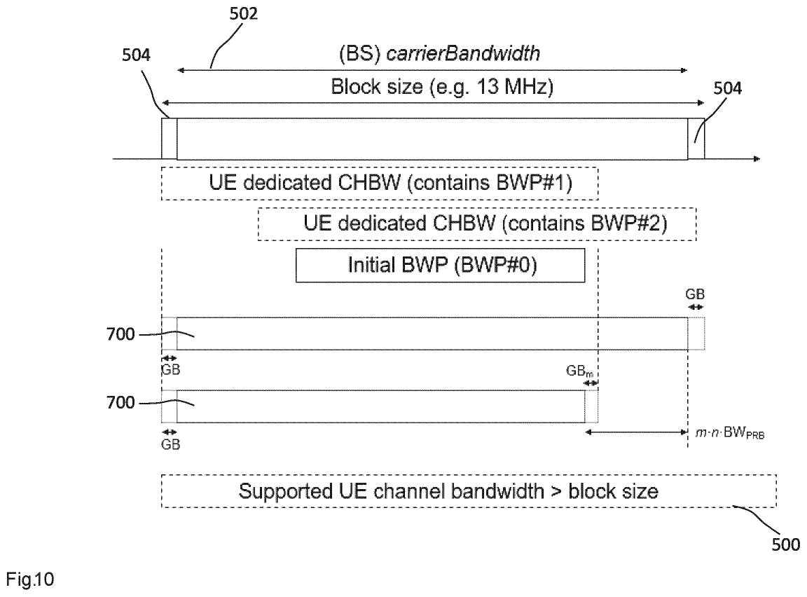

FIG. 10 schematically illustrates an embodiment of an overlapping method, which may be usable by the UE 100 and base station 200 performing the methods 300 and 400, respectively.

The values m and n could be chosen to match other granularities such as that configurable for TRS (e.g., Total Radiated Sensitivity or Tracking Reference Signal), e.g. n=4. Then the grids of the irregular bandwidths supported by the UE 100 are

CBWₘ=GB+(N_{CHBW}−4·m)BW_{PRB}+GBₘ

such that DL (and possibly the UL) BWP can be assigned aligned with the TRS granularity in the DL.

The network would assign each UE 100 with a BWP size up to the maximum

BWPₘₐₓ=N_{CHBW}−m·n

and such that an irregular bandwidth CBWₘ supported by the UE 100 is less than or equal to the bandwidth of the operator block, e.g. 7 MHz as shown in FIG. 9. The network can then schedule each UE 100 with any size of resource block allocation up to BWPₘₐₓ PRBs according to the UE capability. The UE channel filter can be configured by the network and set by the UE 100 in accordance with the channel bandwidth CHBW but the UE 100 would also be compliant with the transmitter requirements for all supported CBWₘ≤CHBW as shown in FIG. 9.

Using the blanking method, the initial BWP can be configured to be equal to the maximum transmission bandwidth configuration of the CHBW_{low} for UEs 100 not supporting irregular bandwidths. Then these UEs 100 meet unwanted-emissions requirements outside the operator block. If CHBW_{low} is not supported by the UE 100, the scheduled PRB could be restricted to the said initial BWP size (with uncertain but likely compliance with the unwanted-emissions requirements outside the operator block) or the UE 100 could be redirected.

In a second embodiment, the UE 100 determines an MPR for compliance with unwanted-emissions requirements with an irregular bandwidth according to outer PRB allocations regardless of the actual PRB allocation and the size of the blanked part of the carrierBandwidth if the use of PRB blanking is indicated in system information or dedicated signaling (e.g., as described in any one of below paragraphs).

In a variation, the UE 100 determines an MPR for compliance with unwanted-emissions requirements with an irregular bandwidth and the boundaries between inner, outer and edge PRB allocations by replacing the maximum transmission bandwidth configuration of the CHBW or configured UE-dedicated channel bandwidth by the active PRB size (FIG. 9 as indicated by the network in the system information or in dedicated signaling (to each UE 100).

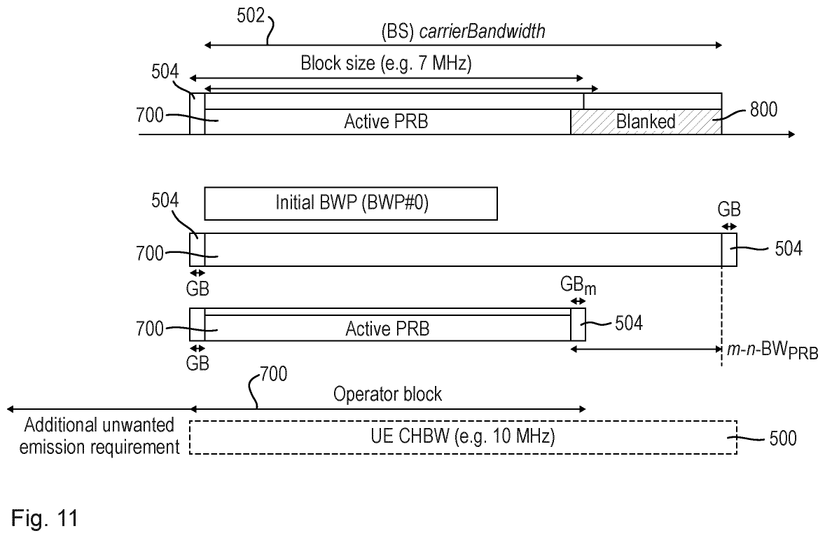

In a third embodiment, the UE 100 determines an A-MPR for compliance with additional unwanted-emissions requirements using the maximum transmission bandwidth configuration of the supported CHBW regardless of the actual PRB allocation and the size of the blanked part of the carrierBandwidth, e.g., as illustrated in FIG. 11. The UE 100 would then comply with the said additional requirement outside the UE channel bandwidth, i.e. below the operator block in FIG. 11, but not necessarily in the blanked part.

In a variation, the UE 100 determines an A-MPR for compliance with additional unwanted-emissions requirements with an irregular bandwidth and the boundaries between PRB allocations allowing different A-MPR by replacing the maximum transmission bandwidth configuration of the CHBW or configured UE-dedicated channel bandwidth by the active PRB size (e.g., according to FIG. 9) as indicated by the network in the system information or in dedicated signaling (to each UE 100).

FIG. 11 schematically illustrates an example of a situation using power reduction, which may be usable by the UE 100 and base station 200 for performing the methods 300 and 400, respectively. More specifically, FIG. 11 illustrates compliance with additional unwanted-emissions requirements (e.g., the fulfilling the limit beyond the channel bandwidth 500).

In any embodiment, the UE 100 and/or the network 200 may (e.g., mutually) indicate irregular channel bandwidths 700, e.g., as described below.

In a first embodiment the network indicates in the system information (cell specific) or in dedicated signaling (to each UE 100) that an irregular bandwidth is used in the cell.

In a variation the UE 100 uses the indication that irregular bandwidth is used to determine if the cell is suitable depending on its support of irregular channel bandwidths. Legacy UEs would not understand the indication but could be redirected by the network or use PRB allocations within the initial BWP suitably configured.

In another variation the UE 100 uses the information that an irregular bandwidth is used for determining the MPR or A-MPR needed for compliance with (additional) unwanted-emissions requirements.

In a second embodiment the network indicates the number of active PRB or the number of blanked PRBs in the system information or in dedicated signaling. This information can be used by the UE 100 for determining the MPR or A-MPR needed for compliance with (additional) unwanted-emissions requirements. In one example the network indicates in dedicated signaling the number of active (or blanked) PRB to be assumed by the UE 100 for MPR or A-MPR determination based on the irregular bandwidth(s) CBWₘ supported by the said UE 100. This could be indicated as an extension to the ServingCellConfig (dedicated) for example.

Any embodiment may use an aggregation of carriers of irregular channel bandwidths and/or supplementary uplinks of irregular bandwidths, e.g., as described below.

The UE 100 uses the channel bandwidth of component carriers to determine if an intra-band CA configuration is contiguous or non-contiguous (the UE 100 may only support one of these if any at all).

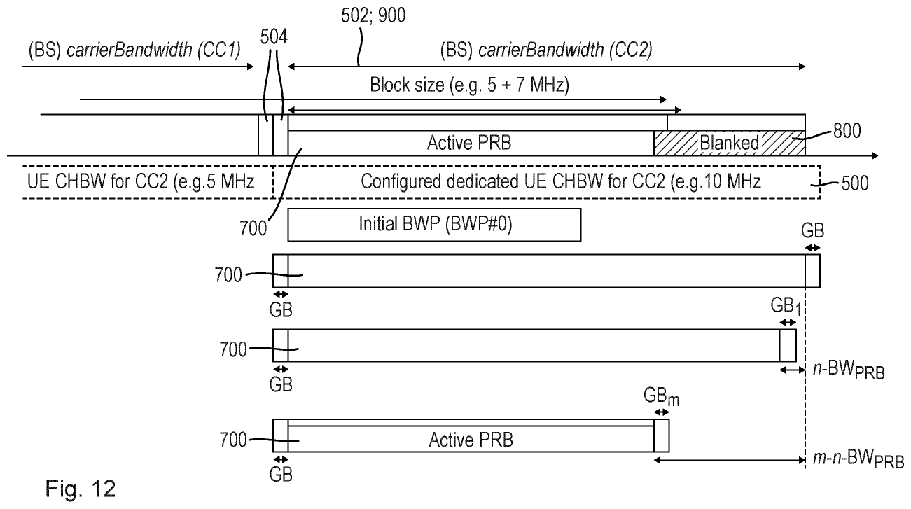

In a first embodiment the UE 100 uses channel bandwidth corresponding to the carrierBandwidth or a configured dedicated UE channel bandwidth to determine if two intra-band component carriers are contiguous or non-contiguous. In the example shown in FIG. 12 a 5 MHz carrier (CC1) is aggregated with a component carrier (CC2) 900 of irregular bandwidth, a carrier of 10 MHz channel bandwidth with blanked PRBs. The UE 100 may use the 10 MHz channel bandwidth corresponding to the carrierBandwidth of the CC2 or be configured by the network with a dedicated 10 MHz channel bandwidth including frequency assignment. The UE 100 uses the said 5 MHz and 10 MHz channel bandwidths to determine if the intra-band CA combination is contiguous or non-contiguous and the network uses the supported UE CA capability to configure the UE 100 with CA if supported.

FIG. 12 schematically illustrates an example of a carrier aggregation (CA), which may be usable by the UE 100 and base station 200 for performing the methods 300 and 400, respectively. More specifically, FIG. 12 illustrates an aggregation of carriers of irregular bandwidths 700.

Inter-band CA of carriers of irregular bandwidths with component carriers in other bands can be supported using existing technology, the embodiments above used for the component carrier of irregular bandwidth.

In another embodiment the methods above are ushed for a supplementary uplink of irregular bandwidth.

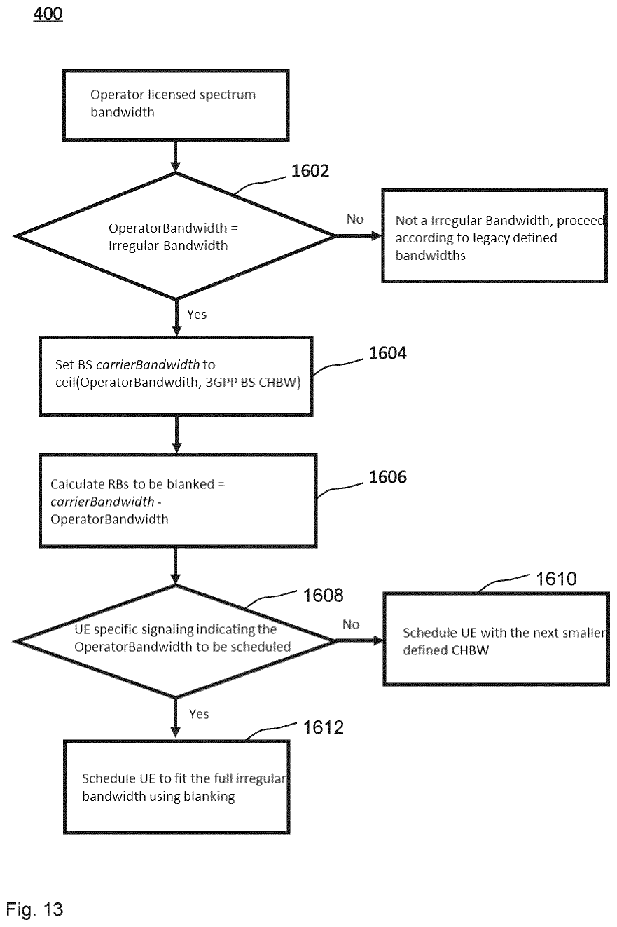

FIG. 13 schematically illustrates flowchart for an example implementation of the method 400. More specifically, FIG. 13 shows a logical flow of decisions taken for a case in which operator bandwidth is an irregular bandwidth 700 and hence not aligned with 3GPP channel bandwidths 500 (e.g., of 5 MHz increments). The method 400 is applied for an operator licensed spectrum bandwidth. The network node 200, determines that the operator bandwidth is not in the discrete set of channel bandwidths as specified by the RAT (block 1602). If the operator bandwidth is a regular bandwidth, the network node 200 proceeds according to legacy defined bandwidths and procedures. If the operator bandwidth is an irregular bandwidth, the network node 200 sets the carrier bandwidth equal to the next regular channel bandwidth greater than the operator bandwidth (block 1604). Once the carrier bandwidth is determined, the network node 200 calculates the number of RBs to be blanked by subtracting the operator bandwidth from the carrier bandwidth.

The UE 100 and network node 200 engage is signaling to determine the size of a BWP to be scheduled (block 1608). For example, the network node 200 can indicate to the UE 100 the irregular operator bandwith and/or the UE 100 can signal to the network node 200 a capability to limit radio emissions outside the irregular operator bandwidth. If the does not indicate support for irregular bandwidths, the network node schedules the

UE 100 with the next smaller channel bandwidth (block 1610). If the UE 100 indicates a capability to limit emissions outside of the irregular bandwidth, the network node 200 can select a BWP size to fit the irregular operator bandwidth (block 1612).

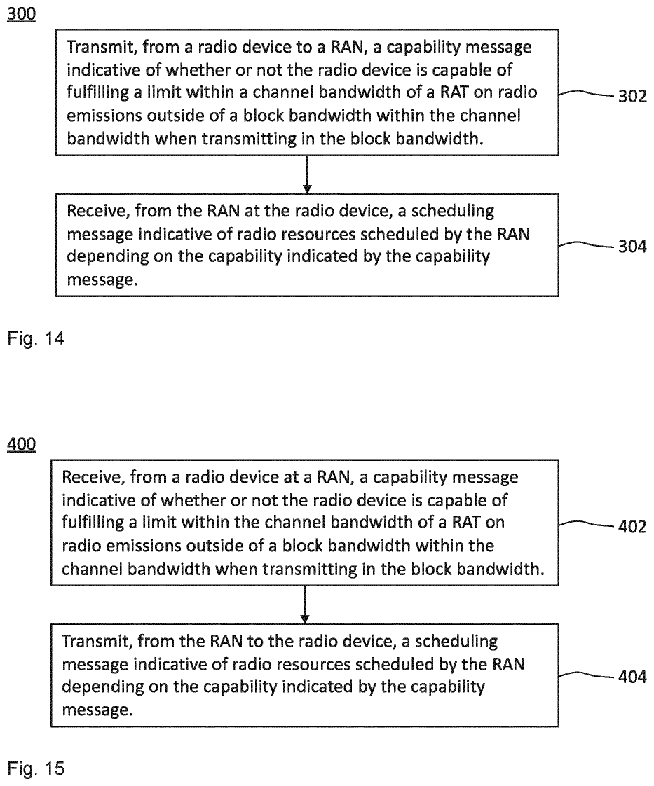

FIG. 14 illustrates a method 300 implemented by a UE100 of using an irregular bandwidth within a regular channel bandwidth defined by the applicable RAT. The method 300 may be applied to uplink (UL), downlink (DL) or direct communications between UEs 100, e.g., device-to-device (D2D) communications or sidelink (SL) communications. The UE 100 transmits a capability message 1100 indicative of whether the UE 100 is capable of fulfilling a limit within the channel bandwidth 500 of the RAT on radio emissions outside of the block bandwidth 700 when transmitting in the block bandwidth 700. The UE 100 receives from the RAN at the radio device, a scheduling message indicative of radio resources 502 scheduled by the RAN depending on the capability indicated by the capability message 1100.

The limit may be a limit within the channel bandwidth of the RAT on radio emissions outside of radio resources 502 within the block bandwidth 700 when transmitting on the radio resources 502 within the block bandwidth. The expression “when transmitting” may encompass “when the radio device is transmitting” or “when the radio device would be transmitting”.

Each of the radio resources 502 may comprise or correspond to a resource block (RB), e.g., physical RB (PRB), or any unit of radio resources 502 in the frequency domain which is allocatable by the base station 200 to the radio device.

The block bandwidth 700 may be any part of radio spectrum not specified by the RAT or not (e.g., directly) allocatable to the radio device according to the RAT.

The radio emissions of the UE 100 outside of the radio resources scheduled by the base station 200 may be spurious emissions.

The channel bandwidth 500 of the RAT may be referred to as the covering channel bandwidth for the block bandwidth, e.g., since the channel bandwidth covers the block bandwidth, i.e., the block bandwidth is within the channel bandwidth.

Being capable of fulfilling the limit by the UE 100 (e.g., within the channel bandwidth of the RAT) on radio emissions outside of scheduled radio resources or the block bandwidth (e.g., when transmitting on the scheduled radio resources or in the block bandwidth) may also be referred to as a blanking capability (or briefly: the capability) of the radio device or as fulfilling the limit by the UE 100. Alternatively or in addition, the limit (e.g., within the channel bandwidth of the RAT) on radio emissions outside of scheduled radio resources or the block bandwidth (e.g., when transmitting on the scheduled radio resources or in the block bandwidth) may also be referred to as a blanking requirement (or briefly: the requirement) or as the limit.

The UE 100 may be scheduled with a carrier bandwidth in the block bandwidth (i.e., the radio device may be scheduled within the block bandwidth) that narrower than a carrier bandwidth in the channel bandwidth 500 of the RAT. The radio device may be capable of fulfilling the limit whenever the radio device is scheduled with a carrier bandwidth in any block bandwidth within the channel bandwidth.

The limit (e.g., on radio emissions outside of the block bandwidth) may correspond to a regulatory requirement for the base station 200 and/or a local requirement of the base station 200. For example, the limit may be required (e.g., for the radio access to the base station 200) in one or more cells of the base station 200. Alternatively or in addition, the limit may be an unwanted-emissions requirement for the radio device, i.e., a requirement as to unwanted radio-frequency emissions from the radio device.

The radio resources 502 may be scheduled for a transmission in the block bandwidth 700 within the channel bandwidth 500 of the RAT, if the UE 100 fulfills the limit.

The radio resources 502 may be dynamically scheduled. Alternatively or in addition, the radio resource may be semi-persistently scheduled. For example, the scheduled radio resources may comprise periodic radio resources.

The scheduling message may be indicative of scheduled radio resources 502 in the block bandwidth 700 for the scheduled transmission. Radio resources outside of the block bandwidth 700 may be blanked, e.g., excluded from being scheduled by the base station 200. The base station 200 may refrain from scheduling radio resources in a blanked bandwidth that is within the channel bandwidth of the RAT and outside of block bandwidth.

The block bandwidth 700 within the channel bandwidth 500 of the RAT may be smaller (i.e., less in size, e.g., less in the number of radio resources) than the channel bandwidth of the RAT. For example, a number of radio resources (e.g., PRBs or sub-carriers) in the block bandwidth may be less than the number of radio resources (e.g., PRBs or sub-carriers) in the channel bandwidth of the RAT. When transmitting in the block bandwidth, radio resources at the edges of the block bandwidth may be excluded from the scheduling by the base station 200 and/or may function as guard bands to fulfill the limit.

Examples of the size of the channel bandwidth 500 may comprise 5 MHz, 10 MHz, 15 MHz, 20 MHz, 25 MHz, 30 MHz, 40 MHz, 50 MHz, 60 MHz, 70 MHz, 80 MHz, 90 MHz, and 100 MHz.

Examples of the size of the block bandwidth 700 may comprise 3 MHz, 7 MHz, and 13 MHz.

In some embodiments of the method 300, the limit comprises a power limit on power emitted by the radio device in a blanked bandwidth (800) within the channel bandwidth (500) and outside of the block bandwidth (700) when transmitting on the scheduled radio resources (502) or all radio resources (502) in the block bandwidth (700). Alternatively or in addition, the limit may comprise a temporal limit and/or a statistical limit on the radio emissions outside of the scheduled radio resources and/or outside of the blanked bandwidth when transmitting on the scheduled radio resources or on any or all radio resources in the block bandwidth.

Transmitting on all radio resources in the block bandwidth may be comprise all radio resources according to a maximum transmission bandwidth configuration of the block bandwidth and/or all radio resources within guard bands at the edges of the block bandwidth.

The radio device may fulfill the limit (e.g., may indicate the blanking capability or the fulfillment of the blanking requirement) if (e.g., only if) the radio device is capable of fulfilling the power limit on power emitted by the radio device in the blanked bandwidth within the channel bandwidth and outside of the block bandwidth when transmitting on (e.g., any or all) radio resources in the block bandwidth.

Herein, the expression bandwidth (e.g., the block bandwidth, the channel bandwidth, and/or the blanked bandwidth) may encompass a connected region in the frequency domain. For brevity, a size of the bandwidth may also be referred to by the expression bandwidth. For example, the expression “x MHz bandwidth” may encompass a bandwidth the size of which is x MHz.

Herein, an expression of the from “A, B, and/or C” or “A; B; and/or C” may encompass any element and/or any subset of the set {A, B, C}.

Each bandwidth (e.g., the block bandwidth, the channel bandwidth, and/or the blanked bandwidth) may be in the radio frequency spectrum. In other words, the expression bandwidth may encompass a connected region of the radio frequency spectrum. For example, each bandwidth may be in the 700 MHz band, in the 3GPP band n28, in a frequency range greater than 700 MHz, and/or less than 2 GHz or 5 GHz.

The capability message may be indicative of whether or not the radio device is capable of fulfilling a limit on power emitted in the blanked bandwidth within the channel bandwidth. The blanked bandwidth may correspond to unwanted radio-frequencies of the unwanted-emissions requirement.

The power may be a spectral power density in the blanked bandwidth. Alternatively or in addition, the limit may be an upper limit on the power. For example, the radio device may fulfil the limit if the power density is less than the limit in the blanked bandwidth, e.g., if the power density is less than the limit throughout the blanked bandwidth.

The blanked bandwidth and the block bandwidth may be disjoint (i.e., disjoint regions in the frequency domain) or non-overlapping. Alternatively or in addition, the blanked bandwidth and/or the block bandwidth may be a part of the channel bandwidth. The blanked bandwidth and/or the block bandwidth may be smaller than the channel bandwidth.

The scheduled transmission may be an uplink (UL) transmission from the radio device to the base station 200, a downlink (DL) transmission from the base station 200 to the radio device, or a sidelink (SL) transmission from the radio device to another radio or from another radio device to the radio device.

The base station 200 may comprise one or more base stations. A serving base station of the base station 200 (i.e., a base station serving the radio device) may at least one of receive the capability message; transmit the scheduling information; and/or provide radio access according to the RAT.

The transmitting in the block bandwidth may observe guard bands that separate the radio resources used for the transmitting from edges of the block bandwidth.

In some embodiments of the method 300, all radio resources (502) in the block bandwidth (700) are separated from edges of the block bandwidth (700) by guard bands (504). In one example, all radio resources in the block bandwidth may be on a carrier bandwidth that is separated from edges of the block bandwidth by guard bands.

The capability message may be indicative of the blanking capability of the radio device if the radio device is capable of fulfilling the limit for any block bandwidth within the channel bandwidth. For example, the radio device may be capable of fulfilling the limit for when dynamically scheduled for transmission on radio resource within the channel bandwidth and/or without configuring the radio device for the block bandwidth.

The scheduled radio resources and/or the guard bands (e.g., framing the scheduled radio resources) may define the block bandwidth.

In some embodiments of the method 300, the blanked bandwidth (800) outside of the block bandwidth (700) and/or the guard bands (504) framing the scheduled radio resources (502) within the block bandwidth (700) are unscheduled radio resources (502) in the channel bandwidth (500). The blanked bandwidth and/or the guard bands may be an part of the channel bandwidth unscheduled by the base station 200. The blanked bandwidth and/or the guard bands may be unscheduled by the base station 200. The blanked bandwidth and/or the guard bands may be (e.g., dynamically) defined by the base station 200 refraining from scheduling radio resources in the blanked bandwidth and/or in the guard bands.

In some embodiments of the method 300, the channel bandwidth (500) is selectable from a discrete set of channel bandwidths (500) of the RAT. The channel bandwidth may be selectable by the base station 200, e.g., by the serving base station of the base station 200 serving the radio device, from the discrete set. The discrete set may relate to the selectable channel bandwidths (e.g., only) in terms of sizes of the channel bandwidths in the discrete set and/or independent of (e.g., potential) locations of the channel bandwidths in the frequency domain. In other words, the discrete set may be a discrete set of sizes for the channel bandwidth.

The set of channel bandwidths may be a discrete set, if there is a positive epsilon so that for each channel bandwidth (CHBW) in the set there is no other channel bandwidth (CHBW′) in the set fulfilling CHBW epsilon<CHBW′<CHBW+epsilon. For example, epsilon may be equal to 5 MHz.

The discrete set may comprise at least two of 5 MHz, 10 MHz, 15 MHz, 20 MHz, 25 MHz, 30 MHz, 40 MHz, 50 MHz, 60 MHz, 70 MHz, 80 MHz, 90 MHz, and 100 MHz.

In some embodiments of the method 300, the block bandwidth (700) is different from all channel bandwidths (500) selectable according to the RAT or in the discrete set. The block bandwidth may be different from all channel bandwidths in the discrete set. For example, a size of the block bandwidth may be different from the sizes of all channel bandwidths in the discrete set or selectable according to the RAT. The block bandwidth may be referred to as an irregular bandwidth.

In some embodiments of the method 300, the channel bandwidth (500) is the smallest channel bandwidth (500) comprising the block bandwidth (700) among the channel bandwidths (500) selectable according to the RAT or in the discrete set.

In some embodiments of the method 300, the scheduled radio resources (502) are within the block bandwidth (700), if the capability message (1100) is indicative of the radio device being capable of fulfilling the limit on radio emissions outside of the block bandwidth (700). The scheduled radio resources may be within the block bandwidth, if the capability message is indicative of the blanking capability, i.e., the radio device being capable of fulfilling the limit (e.g., within the channel bandwidth of the RAT) on radio emissions outside of the block bandwidth (e.g., when transmitting in the block bandwidth).

In some embodiments of the method 300, the scheduled radio resources (502) are within another channel bandwidth (500) within the block bandwidth (700), if the capability message (1100) is not indicative of the radio device being capable of fulfilling the limit on radio emissions outside of the block bandwidth (700). The scheduled radio resources may be within another channel bandwidth within the block bandwidth, if the capability message is not indicative of the blanking capability, i.e., if the capability message is not indicative of the radio device being capable of fulfilling the limit (e.g., within the channel bandwidth of the RAT) on radio emissions outside of the block bandwidth (e.g., when transmitting in the block bandwidth).

The radio resources may be scheduled within the other channel bandwidth according to a maximum transmission bandwidth configuration and/or by scheduling all radio resources within guard bands at the edges of the other channel bandwidth.

The other channel bandwidth may be another channel bandwidth selectable according to the RAT or in the discrete set. The other channel bandwidth may be referred to as the partial channel bandwidth of the block bandwidth, since the other channel bandwidth is a part of the block bandwidth, i.e., the other channel bandwidth is within the block bandwidth.

The other channel bandwidth may be a channel bandwidth other than the channel bandwidth comprising the block bandwidth, e.g., since the other channel bandwidth is within the block bandwidth.

The other channel bandwidth may be the smallest channel bandwidth selectable according to the RAT or in the discrete set. Alternatively or in addition, the other channel bandwidth may be the greatest channel bandwidth which is selectable according to the RAT or in the discrete set and which comprises the block bandwidth. For example, the size of the other channel bandwidth may be 5 MHz.

In some embodiments of the method 300, the block bandwidth (700) is smaller than each of the channel bandwidths (500) selectable according to the RAT or in the discrete set. The block bandwidth may be smaller than all channel bandwidths in the discrete set. For example, a size of the block bandwidth may be less than the sizes of all channel bandwidths in the discrete set or selectable according to the RAT. The block bandwidth may be too small for regular carrier allocation according to the RAT.

In some embodiments of the method 300, the scheduled radio resources (502) are in another channel bandwidth (500) not comprising the block bandwidth (700), if the capability message (1100) is not indicative of the radio device being capable of fulfilling the limit on radio emissions outside of the block bandwidth (700).

The scheduled radio resources may be in another channel bandwidth not comprising the block bandwidth, if the capability message is not indicative of the blanking capability, i.e., if the capability message is not indicative of the radio device being capable of fulfilling the limit (e.g., within the channel bandwidth of the RAT) on radio emissions outside of the block bandwidth (e.g., when transmitting in the block bandwidth).

The other channel bandwidth may be a channel bandwidth disjoint from the channel bandwidth that comprises the block bandwidth.

The base station 200 may refrain from scheduling radio resource within the block bandwidth for the radio device if the radio device does not fulfill the limit on radio emissions outside of the block bandwidth.

The other channel bandwidth may be another channel bandwidth selectable according to the RAT or in the discrete set.

The capability message may be not indicative of the radio device being capable of fulfilling the limit (e.g., within the channel bandwidth of the RAT) on radio emissions outside of the block bandwidth (e.g., when transmitting in the block bandwidth) if information is absent in the capability message as to whether or not the radio device is capable of fulfilling the limit (e.g., within the channel bandwidth of the RAT) on radio emissions outside of the block bandwidth (e.g., when transmitting in the block bandwidth). Alternatively or in addition, the capability message may be not indicative of the radio device being capable of fulfilling the limit (e.g., within the channel bandwidth of the RAT) on radio emissions outside of the block bandwidth (e.g., when transmitting in the block bandwidth) if the capability message is (e.g., expressly) indicative that the radio device is not capable of fulfilling the limit (e.g., within the channel bandwidth of the RAT) on radio emissions outside of the block bandwidth (e.g., when transmitting in the block bandwidth).

In some embodiments of the method 300, a transmission scheduled by the scheduling message is an uplink transmission from the radio device to the base station 200 or the method (300) further comprises transmitting on the schedule radio resources (502). The block bandwidth may comprise at least one or a carrier bandwidth allocated to the radio device and a physical uplink channel of the base station 200, e.g., a physical uplink shared channel (PUSCH) and/or a physical uplink control channel (PUCCH).

In some embodiments of the method 300, the capability message (1100) is a capability information element and/or radio resource control, RRC, signaling. The capability message may be or may comprise the information element (IE) UECapabilityInformation.

Some embodiments of the method 300 further comprise receiving, from the base station 200 at the radio device, a configuration message indicative of at least one of the block bandwidth (700) and the blanked bandwidth (800).

In some embodiments of the method 300, the configuration message is comprised in system information, SI, or dedicated signaling.

In some embodiments of the method 300, the configuration message is indicative of a carrier bandwidth in the block bandwidth (700) for at least one of an uplink, a downlink, and a sidelink and/or a size of the block bandwidth (700).

In some embodiments of the method 300, the configuration message is indicative of at least one of a number of radio resources (502) scheduled or schedulable in the block bandwidth (700) and a number of radio resources (502) excluded from being scheduled or schedulable in the blanked bandwidth (800).

Some embodiments of the method 300 further comprise applying a power reduction in the block bandwidth (700) to fulfill the limit responsive to or based on the configuration message. The power reduction may be an allowed maximum power reduction (MPR) and/or an addition MPR (A MPR). Alternatively or in addition, the configuration message may be indicative of the power reduction and/or the allowed MPR or A-MPR for at least one of inner radio resources (e.g., inner PRBs) within the block bandwidth, edge radio resources (e.g., edge PRBs) at the edges of the block bandwidth, and/or outer radio resources (e.g., outer PRBs) outside of the block bandwidth.

In some embodiments of the method 300, the block bandwidth (700) comprises a carrier allocated to the radio device for a supplementary uplink, SUL, to the base station 200.

In some embodiments of the method 300, the block bandwidth (700) comprises a component carrier (900), of a carrier aggregation for the radio access to the base station 200. The CC within the block bandwidth may be allocated to the radio device for the CA.

Some embodiments of the method 300 further comprise determining whether the CC (900) is contiguous or non-contiguous with a further CC (900) of the CA for the radio access to the base station 200.

In some embodiments of the method 300, the block bandwidth (700) comprises a carrier corresponding to a cell of the base station 200 for dual connectivity (DC) of the radio device to the base station 200. The carrier within the block bandwidth may be allocated to the radio device for the DC. The carrier within the block bandwidth may correspond to a cell in a primary cell group or a secondary cell group of the DC.

Some embodiments of the method 300 further comprise receiving, from the base station 200 at the radio device, a configuration message indicative of a bandwidth part, BWP, of the channel bandwidth (500) that is configured for the radio device within the block bandwidth (700). The BWP may be configured for at least one of an uplink, a downlink, and a sidelink of the radio device. All radio resources in the channel bandwidth outside of the carrier bandwidth and/or the BWP may be blanked (e.g., may be in the blanked bandwidth), i.e., not scheduled according to the scheduling message from the base station 200.

In some embodiments of the method 300, a size of the BWP is the maximum size for a BWP within the block bandwidth (700).

In some embodiments of the method 300, the capability message (1100), or a further message transmitted from the radio device to the base station 200, is further indicative of one or more sizes for the block bandwidth (700).

In some embodiments of the method 300, the block bandwidth (700) comprise:

N_{BLBW}=N_{CHBW}−m·n for m=1,2, . . .

in terms of N_{BLBW} radio resources (502) scheduled or schedulable within the block bandwidth (700), wherein N_{CHBW} is the number of radio resources (502) in the channel bandwidth (500) and n is a preconfigured positive integer. The number of N_{CHBW} radio resources in the channel bandwidth may correspond to a maximum transmission configuration of the channel bandwidth, e.g., the number of N_{RB} RBs (e.g., PRBs) according to the table 5.3.2-1 of the 3GPP document 38.101-1, version 17.0.0. For example, n=2 or 4.

In some embodiments of the method 300, the sizes for the block bandwidth (700) comprise

CBWₘ=2·GB+(N_{CHBW}−m·n)·BW_{RR} for m=1,2, . . .

wherein GB is the size of each of the guard bands (504) at the edges of the block bandwidth (700) or the channel bandwidth (500), BW_{RR} is the bandwidth per radio resource, N_{CHBW} is the number of radio resources (502) in the channel bandwidth (500), and n is a preconfigured positive integer. The bandwidth BW_{RR} per radio resource may correspond to 12 sub-carriers per PRB (as the radio resource).

In some embodiments of the method 300, the sizes for the block bandwidth (700) comprise:

CBWₘ=GB+(N_{CHBW}−m·n)·BW_{RR}+GBₘ for m=1,2, . . .

wherein GB is the size of a guard band (504) at an edge of the channel bandwidth (500), GBₘ is the size of a guard band (504) at an edge of the block bandwidth (700) within the channel bandwidth (500), BW_{RR} is the bandwidth per radio resource, N_{CHBW} is the number of radio resources (502) in the channel bandwidth (500), and n is a preconfigured positive integer.

In some embodiments of the method 300, the sizes for the block bandwidth (700) comprise:

N_{BLBW}=N_{CHBW, low}+m·n for m=1,2, . . .

in terms of N_{BLBW} radio resources (502) scheduled or schedulable within the block bandwidth (700), wherein N_{CHBW, low} is the number of radio resources (502) in the greatest channel bandwidth (500), which is selectable according to the RAT or in the discrete set and which is smaller than the channel bandwidth (500), and n is a preconfigured positive integer. The number of N_{CHBW, low} radio resources in the greatest channel bandwidth smaller channel bandwidth CHBW may correspond to a maximum transmission configuration of the greatest channel bandwidth smaller channel bandwidth CHBW.

The method of any one of claims 25-29, wherein the sizes for the block bandwidth (700) comprise:

CBWₘ=2·GB+(N_{CHBW, low}+m·n)·BW_{RR} for m=1,2, . . .

wherein GB is the size of each of the guard bands (504) at the edges of the block bandwidth (700) or the channel bandwidth (500), BWRR is the bandwidth per radio resource, NCHBW, low is the number of radio resources (502) in the greatest channel bandwidth (500), which is selectable according to the RAT or in the discrete set and which is smaller than the channel bandwidth (500), and n is a preconfigured positive integer. The bandwidth BW_{RR} per radio resource may correspond to 12 sub-carriers per PRB (as the radio resource).

In some embodiments of the method 300, comprise:

CBWₘ=GB+(N_{CHBW}−m·n)·BW_{RR}+GBₘ for m=1,2, . . .

wherein GB is the size of a guard band (504) at an edge of the channel bandwidth (500), GBm is the size of a guard band (504) at an edge of the block bandwidth (700) within the channel bandwidth (500), BWRR is the bandwidth per radio resource, NCHBW, low is the number of radio resources (502) in the greatest channel bandwidth (500), which is selectable according to the RAT or in the discrete set and which is smaller than the channel bandwidth (500), and n is a preconfigured positive integer.

In some embodiments of the method 300, the sizes for the block bandwidth (700) are limited in accordance with:

CHBW_{low}<CBWₘ<CHBW,

wherein CHBW is the size of the channel bandwidth (500) and CHBWlow is the size of the greatest channel bandwidth (500), which is selectable according to the RAT or in the discrete set and which is smaller than the channel bandwidth (500).

In some embodiments of the method 300, one or more sizes for the block bandwidth (700) match one or more bandwidth sizes for a total radiated sensitivity or a tracking reference signal. The bandwidth sizes for the TRS may be specified by the 3GPP document TS 38.214, version 16.4.0.

FIG. 15 illustrates a method 400 implemented by a base station 200 of scheduling a UE 100 (e.g., UE 100) in a block bandwidth (700) within a channel bandwidth (500) of a radio access technology. The method 300 may be applied to uplink (UL), downlink (DL) or direct communications between UEs 100, e.g., device-to-device (D2D) communications or sidelink (SL) communications. The base station 200 receives, from a UE 100, a capability message (1100) indicative of whether or not the radio device is capable of fulfilling a limit within the channel bandwidth (500) of the RAT on radio emissions outside of the block bandwidth (700) when transmitting in the block bandwidth (700) (block 402). The base station 200 transits, to the UE 100, a scheduling message indicative of radio resources (502) scheduled by the base station 200 depending on the capability indicated by the capability message (1100) (block 404).

Some embodiments of the method 400 further comprise determining (1602) that an operator bandwidth does not correspond to any of the channel bandwidths (500) selectable according to the RAT.

Some embodiments of the method 400 further comprise selecting (1604) among channel bandwidths (500) selectable according to the RAT the channel bandwidth (500) that comprises the operator bandwidth, wherein the block bandwidth (700) corresponds to the operator bandwidth.

In some embodiments of the method 400, the smallest channel bandwidth (500) that comprises the operator bandwidth is selected among channel bandwidths (500) selectable according to the RAT.

Some embodiments of the method 400 further comprise transmitting, from the base station 200 to the UE 100, a configuration message indicative of at least one of the block bandwidth (700) and the blanked bandwidth (800).

Some embodiments of the method 400 further comprise calculating (1606) radio resources (502) excluded from the scheduling based on the channel bandwidth (500) and the block bandwidth (700).

In some embodiments of the method 400, the base station 200 refrains from scheduling radio resources (502) in the channel bandwidth (500) outside of the block bandwidth (700). The base station 200 (e.g., the base station) blanks (i.e., excludes from the scheduling) radio resources in the channel bandwidth outside of the block bandwidth or in a blanked bandwidth that is in the channel bandwidth and outside of the block bandwidth.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

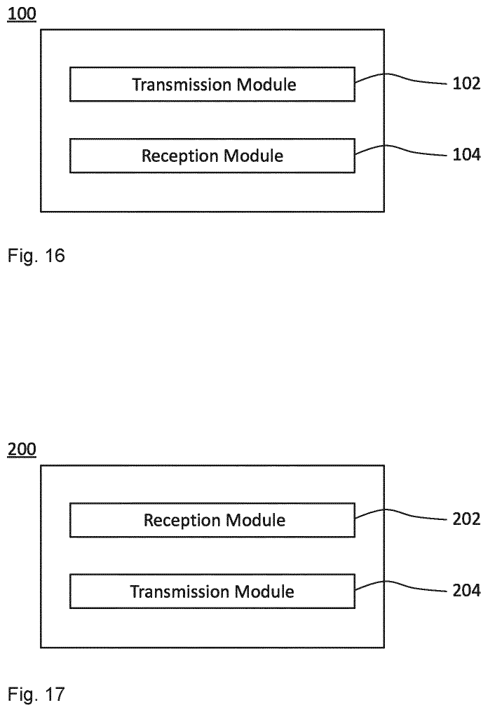

FIG. 16 illustrates an exemplary UE 100 configured to use irregular bandwidths as herein described. The UE 100 comprises a transmission module 102 and a reception module 104. The various modules 102, 104 can be implemented by hardware and/or by software code that is executed by one or more processors or processing circuits. The transmission module 102 is configured to transmit a capability message indicative of whether the radio device is capable of fulfilling a limit within the channel bandwidth of the RAT on radio emissions outside of the block bandwidth when transmitting in the block bandwidth. The reception module 104 is configured to receive, from the base station 200, a scheduling message indicative of radio resources scheduled by the base station 200 depending on the capability indicated by the capability message.

FIG. 17 illustrates an exemplary base station 200 configured to schedule a UE 100 on irregular bandwidths as herein described. The base station 200 comprises a reception module 202 and a transmission module 204. The various modules 202, 204 can be implemented by hardware and/or by software code that is executed by one or more processors or processing circuits. The reception module 202 is configured to receive, from a UE 100, a capability message indicative of whether or not the radio device is capable of fulfilling a limit within the channel bandwidth of the RAT on radio emissions outside of the block bandwidth when transmitting in the block bandwidth. The transmission module 204 is configured to transmit, to the UE 100, a scheduling message indicative of radio resources scheduled by the base station 200 depending on the capability indicated by the capability message.

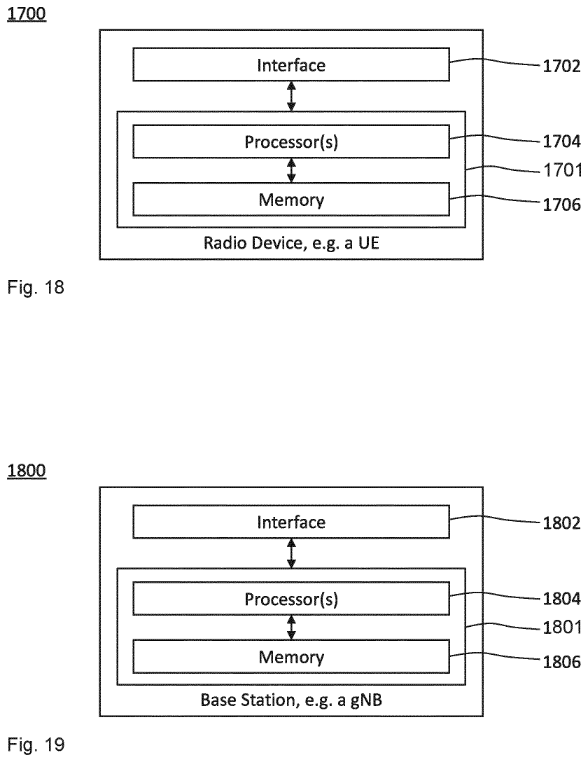

FIG. 18 shows a schematic block diagram for an embodiment of the UE 1700. The UE 100 comprises interface circuitry 1702 for communicating with a base station 200 over a wireless communication channel and processing circuitry 1701 for controlling the operation of the UE 1700 as herein described.

The interface circuit 1701 is coupled to antennas (not shown) of the UE 1700 and comprises the radio frequency (RF) circuitry needed for transmitting and receiving signals over a wireless communication channel. As one example, the interface circuitry 1702 may be configured to operate according the 5G/NR standard.

The processing circuitry 1701 comprises one or more processors 1704 configured to perform the method 300. The one or more processors 1704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1706, UE functionality. For example, the one or more processors 1704 may execute instructions stored in the memory 1706. Such functionality may include providing various features and steps discussed herein, including any of the benefits disclosed herein.

Memory 1706 may comprise any tangible, non-transitory computer-readable storage medium for storing data including electronic, magnetic, optical, electromagnetic, or semiconductor data storage. Memory 1706 stores a computer program comprising executable instructions that configure the processing circuitry 1701 to implement the method 300. A computer program in this regard may comprise one or more code modules corresponding to the means or units described above. The computer program may also be embodied in a carrier such as an electronic signal, optical signal, radio signal, or computer readable storage medium.

FIG. 19 shows a schematic block diagram for an embodiment of a base station 1800. The UE 100 comprises interface circuitry 1802 for communicating with a UE 100 over a wireless communication channel and processing circuitry 1801 for controlling the operation of the base station 1800 as herein described.

The interface circuit 1801 is coupled to antennas (not shown) of the base station 1800 and comprises the radio frequency (RF) circuitry needed for transmitting and receiving signals over a wireless communication channel. As one example, the interface circuitry 1802 may be configured to operate according the 5G/NR standard.

The processing circuitry 1801 comprises one or more processors 1804 configured to perform the method 400. The one or more processors 1804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1806, base station functionality. For example, the one or more processors 1804 may execute instructions stored in the memory 1806. Such functionality may include providing various features and steps discussed herein, including any of the benefits disclosed herein.

Memory 1806 may comprise any tangible, non-transitory computer-readable storage medium for storing data including electronic, magnetic, optical, electromagnetic, or semiconductor data storage. Memory 1806 stores a computer program comprising executable instructions that configure the processing circuitry 1801 to implement the method 300. A computer program in this regard may comprise one or more code modules corresponding to the means or units described above. The computer program may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

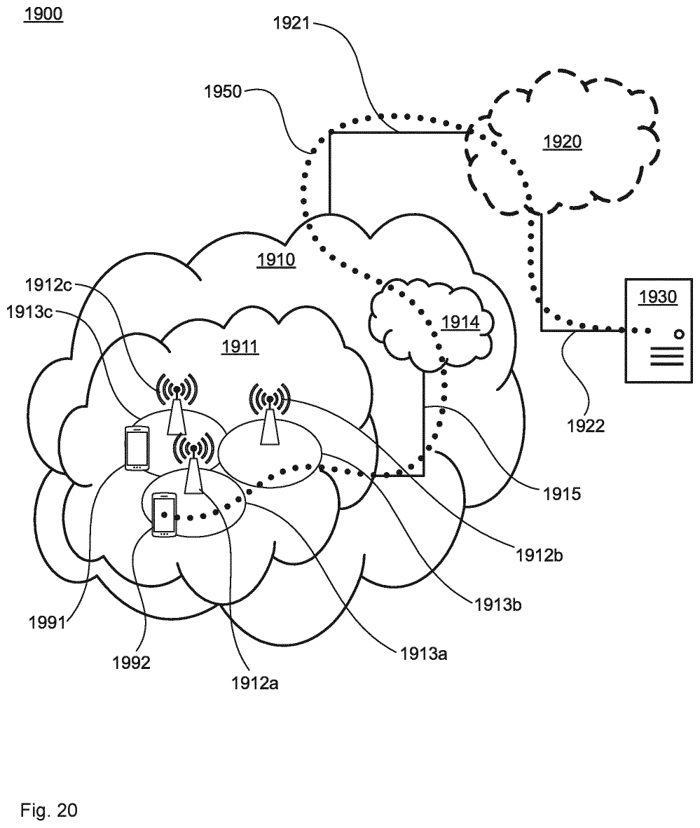

With reference to FIG. 20, in accordance with an embodiment, a communication system 1900 includes a telecommunication network 1910, such as a 3GPP-type cellular network, which comprises an access network 1911, such as a radio access network, and a core network 1914. The access network 1911 comprises a plurality of base stations 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to the core network 1914 over a wired or wireless connection 1915. A first user equipment (UE) 1991 located in coverage area 1913c is configured to wirelessly connect to, or be paged by, the corresponding base station 1912c. A second UE 1992 in coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the corresponding base station 1912.

Any of the base stations 1912 and the UEs 1991, 1992 may embody the device 100.

The telecommunication network 1910 is itself connected to a host computer 1930, which may be embodied in the hardware and/or software of a standalone server, a cloud-implemented server, a distributed server or as processing resources in a server farm. The host computer 1930 may be under the ownership or control of a service provider, or may be operated by the service provider or on behalf of the service provider. The connections 1921, 1922 between the telecommunication network 1910 and the host computer 1930 may extend directly from the core network 1914 to the host computer 1930 or may go via an optional intermediate network 1920. The intermediate network 1920 may be one of, or a combination of more than one of, a public, private or hosted network; the intermediate network 1920, if any, may be a backbone network or the Internet; in particular, the intermediate network 1920 may comprise two or more sub-networks (not shown).

The communication system 1900 of FIG. 20 as a whole enables connectivity between one of the connected UEs 1991, 1992 and the host computer 1930. The connectivity may be described as an over-the-top (OTT) connection 1950. The host computer 1930 and the connected UEs 1991, 1992 are configured to communicate data and/or signaling via the OTT connection 1950, using the access network 1911, the core network 1914, any intermediate network 1920 and possible further infrastructure (not shown) as intermediaries. The OTT connection 1950 may be transparent in the sense that the participating communication devices through which the OTT connection 1950 passes are unaware of routing of uplink and downlink communications. For example, a base station 1912 need not be informed about the past routing of an incoming downlink communication with data originating from a host computer 1930 to be forwarded (e.g., handed over) to a connected UE 1991. Similarly, the base station 1912 need not be aware of the future routing of an outgoing uplink communication originating from the UE 1991 towards the host computer 1930.

By virtue of the method 100 and/or 200 being performed by any one of the UEs 1991 or 1992 and/or any one of the base stations 1912, respectively, the performance or range of the OTT connection 1950 can be improved, e.g., in terms of increased throughput and/or reduced latency. More specifically, the host computer 1930 may indicate to the RAN 200 or a relaying radio device 200 or the radio device 100 (e.g., on an application layer), if the irregular bandwidth is to be used.

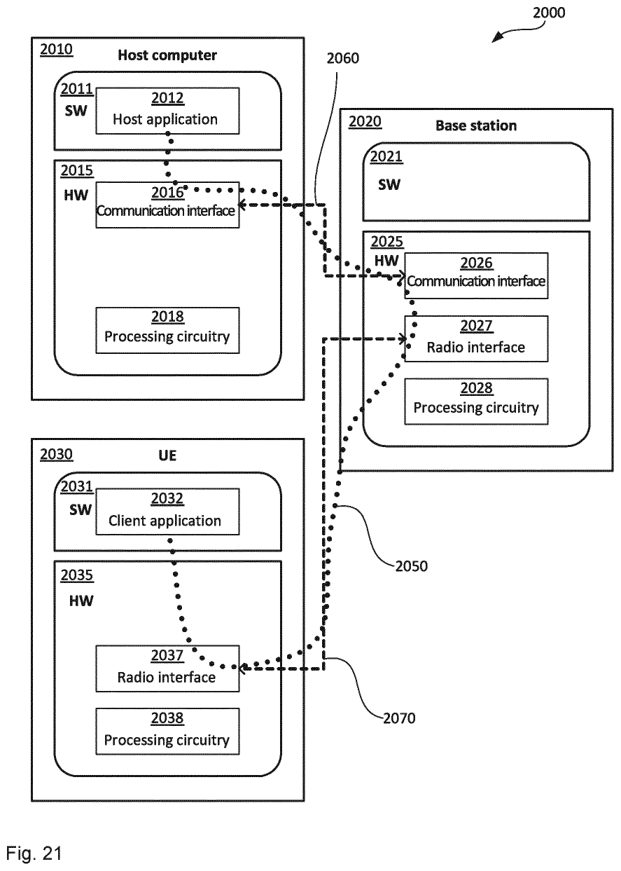

Example implementations, in accordance with an embodiment of the UE, base station and host computer discussed in the preceding paragraphs, will now be described with reference to FIG. 21. In a communication system 2000, a host computer 2010 comprises hardware 2015 including a communication interface 2016 configured to set up and maintain a wired or wireless connection with an interface of a different communication device of the communication system 2000. The host computer 2010 further comprises processing circuitry 2018, which may have storage and/or processing capabilities. In particular, the processing circuitry 2018 may comprise one or more programmable processors, application-specific integrated circuits, field programmable gate arrays or combinations of these (not shown) adapted to execute instructions. The host computer 2010 further comprises software 2011, which is stored in or accessible by the host computer 2010 and executable by the processing circuitry 2018. The software 2011 includes a host application 2012. The host application 2012 may be operable to provide a service to a remote user, such as a UE 2030 connecting via an OTT connection 2050 terminating at the UE 2030 and the host computer 2010. In providing the service to the remote user, the host application 2012 may provide user data, which is transmitted using the OTT connection 2050. The user data may depend on the location of the UE 2030. The user data may comprise auxiliary information or precision advertisements (also: ads) delivered to the UE 2030. The location may be reported by the UE 2030 to the host computer, e.g., using the OTT connection 2050, and/or by the base station 2020, e.g., using a connection 2060.

The communication system 2000 further includes a base station 2020 provided in a telecommunication system and comprising hardware 2025 enabling it to communicate with the host computer 2010 and with the UE 2030. The hardware 2025 may include a communication interface 2026 for setting up and maintaining a wired or wireless connection with an interface of a different communication device of the communication system 2000, as well as a radio interface 2027 for setting up and maintaining at least a wireless connection 2070 with a UE 2030 located in a coverage area (not shown in FIG. 21) served by the base station 2020. The communication interface 2026 may be configured to facilitate a connection 2060 to the host computer 2010. The connection 2060 may be direct, or it may pass through a core network (not shown in FIG. 21) of the telecommunication system and/or through one or more intermediate networks outside the telecommunication system. In the embodiment shown, the hardware 2025 of the base station 2020 further includes processing circuitry 2028, which may comprise one or more programmable processors, application-specific integrated circuits, field programmable gate arrays or combinations of these (not shown) adapted to execute instructions. The base station 2020 further has software 2021 stored internally or accessible via an external connection.

The communication system 2000 further includes the UE 2030 already referred to. Its hardware 2035 may include a radio interface 2037 configured to set up and maintain a wireless connection 2070 with a base station serving a coverage area in which the UE 2030 is currently located. The hardware 2035 of the UE 2030 further includes processing circuitry 2038, which may comprise one or more programmable processors, application-specific integrated circuits, field programmable gate arrays or combinations of these (not shown) adapted to execute instructions. The UE 2030 further comprises software 2031, which is stored in or accessible by the UE 2030 and executable by the processing circuitry 2038. The software 2031 includes a client application 2032. The client application 2032 may be operable to provide a service to a human or non-human user via the UE 2030, with the support of the host computer 2010. In the host computer 2010, an executing host application 2012 may communicate with the executing client application 2032 via the OTT connection 2050 terminating at the UE 2030 and the host computer 2010. In providing the service to the user, the client application 2032 may receive request data from the host application 2012 and provide user data in response to the request data. The OTT connection 2050 may transfer both the request data and the user data. The client application 2032 may interact with the user to generate the user data that it provides.

It is noted that the host computer 2010, base station 2020 and UE 2030 illustrated in FIG. 21 may be identical to the host computer 1930, one of the base stations 1912a, 1912b, 1912c and one of the UEs 1991, 1992 of FIG. 20, respectively. This is to say, the inner workings of these entities may be as shown in FIG. 21, and, independently, the surrounding network topology may be that of FIG. 20.

In FIG. 21, the OTT connection 2050 has been drawn abstractly to illustrate the communication between the host computer 2010 and the UE 2030 via the base station 2020, without explicit reference to any intermediary devices and the precise routing of messages via these devices. Network infrastructure may determine the routing, which it may be configured to hide from the UE 2030 or from the service provider operating the host computer 2010, or both. While the OTT connection 2050 is active, the network infrastructure may further take decisions by which it dynamically changes the routing (e.g., on the basis of load balancing consideration or reconfiguration of the network).

The wireless connection 2070 between the UE 2030 and the base station 2020 is in accordance with the teachings of the embodiments described throughout this disclosure. One or more of the various embodiments improve the performance of OTT services provided to the UE 2030 using the OTT connection 2050, in which the wireless connection 2070 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 2050 between the host computer 2010 and UE 2030, in response to variations in the measurement results. The measurement procedure and/or the network functionality for reconfiguring the OTT connection 2050 may be implemented in the software 2011 of the host computer 2010 or in the software 2031 of the UE 2030, or both. In embodiments, sensors (not shown) may be deployed in or in association with communication devices through which the OTT connection 2050 passes; the sensors may participate in the measurement procedure by supplying values of the monitored quantities exemplified above, or supplying values of other physical quantities from which software 2011, 2031 may compute or estimate the monitored quantities. The reconfiguring of the OTT connection 2050 may include message format, retransmission settings, preferred routing etc.; the reconfiguring need not affect the base station 2020, and it may be unknown or imperceptible to the base station 2020. Such procedures and functionalities may be known and practiced in the art. In certain embodiments, measurements may involve proprietary UE signaling facilitating the host computer's 2010 measurements of throughput, propagation times, latency and the like. The measurements may be implemented in that the software 2011, 2031 causes messages to be transmitted, in particular empty or “dummy” messages, using the OTT connection 2050 while it monitors propagation times, errors etc.

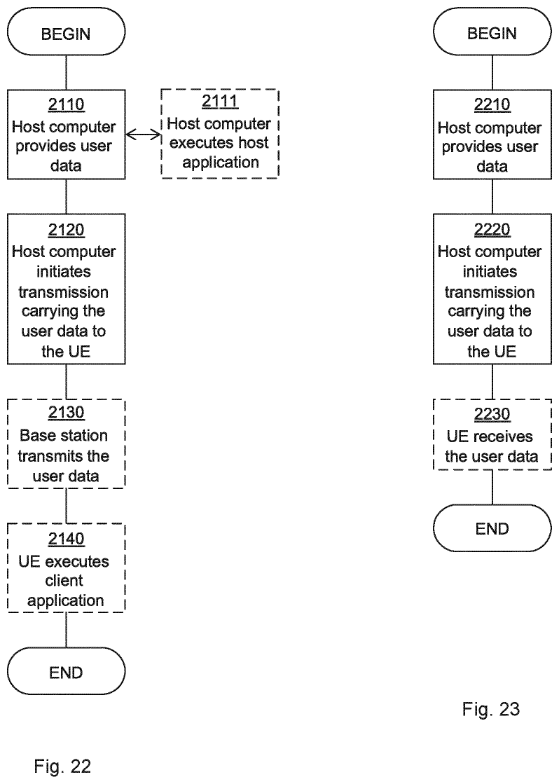

FIG. 22 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 22 will be included in this paragraph. In a first step 2110 of the method, the host computer provides user data. In an optional substep 2111 of the first step 2110, the host computer provides the user data by executing a host application. In a second step 2120, the host computer initiates a transmission carrying the user data to the UE. In an optional third step 2130, the base station transmits to the UE the user data which was carried in the transmission that the host computer initiated, in accordance with the teachings of the embodiments described throughout this disclosure. In an optional fourth step 2140, the UE executes a client application associated with the host application executed by the host computer.

FIG. 23 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 23 will be included in this paragraph. In a first step 2210 of the method, the host computer provides user data. In an optional substep (not shown) the host computer provides the user data by executing a host application. In a second step 2220, the host computer initiates a transmission carrying the user data to the UE. The transmission may pass via the base station, in accordance with the teachings of the embodiments described throughout this disclosure. In an optional third step 2230, the UE receives the user data carried in the transmission.

As has become apparent from above description, at least some embodiments of the technique allow for at least one of the following advantages.

As a first advantage, deployment scenarios may require many permutations of channel bandwidths for both UE and BS implementations. The solution provides a solution whereby BS and UE vendors do not need to support additional channel bandwidths and only implement irregular bandwidths that are only subject to a limited set of transmitter and receiver requirements.

As a second advantage, embodiments of the technique ensures that a UE can operate in an irregular bandwidth larger than 5 MHz without jeopardizing any regulatory RF emission requirements.

As a third advantage, the embodiments of the technique provide a future-proof solution for any new irregular bandwidth.

As a fourth advantage, it also provides backwards combability by allowing existing UEs that are deployed in the field to attach and operate in a network operating with an irregular bandwidth, this since the BS can limit those UEs to operate in for example a 5 MHz channel bandwidth (CHBW).

As a fifth advantage, irregular bandwidths can be used in a cell without specification of additional (regular) channel bandwidths for the BS or UE requiring compliance with the full set of transmitter and receiver RF and RRM requirements. The said irregular bandwidths may only be compliant with the unwanted-emissions requirements (e.g., regulatory requirements), i.e. a small subset of all other requirements. The latter must be met for the (regular) channel bandwidths supported by the BS or UE.

As a sixth advantage, the network can indicate the use of irregular bandwidth(s) for a UE to determine its output power (e.g. MPR) such that the unwanted-emissions requirements can be met for the irregular bandwidth(s) supported by the said UE. This indication can also be used by the UE to determine the suitability of the cell.

As a seventh advantage, the maximum transmission configurations of the irregular bandwidths can be specified with a granularity in terms of PRB with a suitable internal guard band, which allows flexibility of scheduling connected UEs with different irregular bandwidth capabilities (PRB scheduling in accordance with the capability of each UE in the cell).

As an eighth advantage, the range of irregular bandwidth is optional, a subset thereof can be supported by the UE and used by the RAN in accordance with the indicated UE capability.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of any one of the following embodiments in the list of embodiments and/or the still further embodiment.

1-59. (canceled)

60. A method implemented by a user equipment (UE) of operating a UE in a block bandwidth within a channel bandwidth of a radio access technology (RAT), for radio access to a radio access network (base station), the method comprising:
transmitting a capability message indicative of whether the UE is capable of fulfilling a limit within the channel bandwidth of the RAT on radio emissions outside of the block bandwidth when transmitting in the block bandwidth; and
receiving, from a base station in the RAN, a scheduling message indicative of radio resources scheduled by the base station depending on the capability indicated by the capability message, wherein the limit comprises a power limit on power emitted by the UE in a blanked bandwidth within the channel bandwidth and outside of the block bandwidth when transmitting on the scheduled radio resources or all radio resources in the block bandwidth.

61. The method of claim 60, wherein all radio resources in the block bandwidth are separated from edges of the block bandwidth by guard bands.

62. The method of claim 60, wherein the blanked bandwidth outside of the block bandwidth and/or the guard bands framing the scheduled radio resources within the block bandwidth are unscheduled radio resources in the channel bandwidth.

63. The method of claim 60, wherein the channel bandwidth is selectable from a discrete set of channel bandwidths of the RAT.

64. The method of claim 60, wherein the block bandwidth is different from all channel bandwidths selectable according to the RAT or in the discrete set.

65. The method of claim 60, wherein the channel bandwidth is the smallest channel bandwidth comprising the block bandwidth among the channel bandwidths selectable according to the RAT or in the discrete set.

66. The method of claim 60, wherein the block bandwidth is smaller than each of the channel bandwidths selectable according to the RAT or in the discrete set.

67. The method of claim 66, wherein the scheduled radio resources are in another channel bandwidth not comprising the block bandwidth, if the capability message is not indicative of the UE being capable of fulfilling the limit on radio emissions outside of the block bandwidth.

68. The method of claim 60, wherein at least one of:
a transmission scheduled by the scheduling message is an uplink transmission from the UE to the base station; and
the method further comprised or initiates the step of transmitting on the schedule radio resources.

69. The method of claim 60, further comprising or initiating:
receiving, from the base station at the UE, a configuration message indicative of at least one of the block bandwidth and the blanked bandwidth.

70. The method of claim 69, wherein the configuration message is indicative of a carrier bandwidth in the block bandwidth for at least one of an uplink, a downlink, and a sidelink and/or a size of the block bandwidth.

71. The method of claim 69, wherein the configuration message is indicative of at least one of a number of radio resources scheduled or schedulable in the block bandwidth and a number of radio resources excluded from being scheduled or schedulable in the blanked bandwidth.

72. The method of claim 69, further comprising or initiating:
applying a power reduction in the block bandwidth to fulfill the limit responsive to or based on the configuration message.

73. The method of claim 60, wherein the block bandwidth comprises a carrier allocated to the UE for a supplementary uplink (SUL), to the base station.

74. The method of claim 60, wherein the block bandwidth comprises a carrier corresponding to a cell of the base station for dual connectivity (DC), of the UE to the base station.

75. The method of claim 60, further comprising or initiating:
receiving, from the base station at the UE, a configuration message indicative of a bandwidth part (BWP), of the channel bandwidth that is configured for the UE within the block bandwidth.

76. The method of claim 75, wherein a size of the BWP is the maximum size for a BWP within the block bandwidth.

77. The method of claim 60, wherein the capability message, or a further message transmitted from the UE to the base station, is further indicative of one or more sizes for the block bandwidth.

78. The method of claim 60, wherein one or more sizes for the block bandwidth match one or more bandwidth sizes for a total radiated sensitivity or a tracking reference signal.

79. A method implemented by a base station of scheduling a user equipment (UE) operating in a block bandwidth within a channel bandwidth of a radio access technology (RAT), for radio access to a radio access network (RAN), the method comprising or initiating:
receiving, from the UE, a capability message indicative of whether or not the UE is capable of fulfilling a limit within the channel bandwidth of the RAT on radio emissions outside of the block bandwidth when transmitting in the block bandwidth; and
transmitting, to the UE 100, a scheduling message indicative of radio resources scheduled by the RAN depending on the capability indicated by the capability message; and
wherein the limit comprises a power limit on power emitted by the UE in a blanked bandwidth within the channel bandwidth and outside of the block bandwidth when transmitting on the scheduled radio resources or all radio resources in the block bandwidth.
